(19) United States
(12) Patent Application Publication
(10) Pub. No.: US 2017/0357756 A1
(43) Pub. Date: Dec. 14, 2017

(54) SYSTEM AND METHOD FOR DETERMINING AND INDICATING VALUE OF HEALTHCARE

(71) Applicant: Healthcare Value Analytics, LLC, Lufkin, TX (US)

(72) Inventors: George Fidone, Lufkin, TX (US); George Powell, Nashville, TN (US); Norman White, Austin, TX (US); Van Marshall, Sunnyvale, TX (US); Mark Lane, Franklin, TN (US); Justin Fidone, West Linn, OR (US)

(21) Appl. No.: 15/590,382

(22) Filed: May 9, 2017

Related U.S. Application Data
(63) Continuation-in-part of application No. 15/350,910, filed on Nov. 14, 2016.
Application No. 15/350,910 is a continuation-in-part of application No. 15/177,058, filed on Jun. 8, 2016.

(51) Int. Cl. G06F 19/00

(52) U.S. Cl. CPC G06F 19/322; G06F 19/328; G06F 19/327; G06F 19/345; G06F 19/3487

(57) ABSTRACT

A processor-implemented method for determining and indicating values of medical treatment plans includes a processor creating value baselines comprising health metric values for approved plans of care; receiving a request from a client device based on the client device detecting an activity indicating a patient-related event, the request identifying a visit associated with a patient generating a health value continuum based on the visit; generating a comparison of the health value continuum to a value baseline; and providing data and instructions to display on a display page, a representation of the health value continuum to value baseline comparison.

### CROSS-REFERENCE TO RELATED APPLICATIONS

This application is a continuation-in-part of U.S. patent application Ser. No. 15/350,910, entitled “SYSTEM AND METHOD FOR DETERMINING AND INDICATING VALUE OF HEALTH CARE,” filed Nov. 14, 2016, which is a continuation in part of U.S. patent application Ser. No. 15/177,058 entitled “SYSTEM AND METHOD FOR DETERMINING AND INDICATING VALUE OF HEALTH CARE,” filed Jun. 8, 2016. The contents of the above-identified patent document is incorporated herein by reference.

### BACKGROUND

As the cost of providing health care continues to increase at an unsustainable rate, health care providers (especially physicians) are increasingly being held responsible for controlling cost in an effort to provide high quality care while controlling costs. Drivers of this shift in responsibility include the federal government (Medicare, Medicaid, Va., CHiPs), state governments, third party payers (both for-profit and not-for-profit), and Accountable Care Organizations (ACOs) as well as individual hospitals and medical groups. Increasingly, health care providers are being asked to share in the financial risk in providing medical care.

### SUMMARY

A method for determining and indicating values of medical treatment plans includes a processor creating value baselines comprising health metric values for approved plans of care; receiving a request from a client device based on the client device detecting an activity indicating a patient-related event, the request identifying the patient-related event; generating a health value continuum based on the patient-related event; generating a comparison of the health value continuum to a value baseline; and providing data and instructions to the client device to display on a display page, a representation of the health value continuum to value baseline comparison.

A processor-implemented method for determining and indicating values of medical treatment plans includes a processor creating value baselines comprising health metric values for approved plans of care; receiving a request from a client device based on the client device detecting an activity indicating a patient-related event, the request identifying a visit associated with a patient generating a health value continuum based on the visit; generating a comparison of the health value continuum to a value baseline; and providing data and instructions to display on a display page, a representation of the health value continuum to value baseline comparison.

A method for determining and indicating values of medical treatment plans, the method executed over a client-server architecture, including a server creating value baselines comprising health metric values for approved plans of care; a client detecting activity related to medical care for a patient; the client sending and the server receiving a request from the client device identifying a patient visit that has an associated diagnosis; and the server: determining the activity warrants generating a health value continuum, generating a health value continuum corresponding to the diagnosis, generating a comparison of the health value continuum to the value baseline, and providing data and instructions to the client to display a representation of the health value continuum to value baseline comparison.

A method executed by a processor of a health value analytics system in communication with a device external to the health value analytics system, includes the processor receiving an indication of a patient-related event from the external device, the patient-related event referencing a visit of a patient; and based on the visit reference, the processor: determining a need to generate a health value continuum: directing generation of the health value continuum, directing generation of a comparison of the health value continuum to a value baseline for an approved plan of care, and directing the provision of data and instructions to display on a display page, a representation of the health value continuum to value baseline comparison.

A method for determining and indicating values of medical treatment plans, includes a server, in communication with a client: receiving from the client a communication defining a patient-related event; the server, in response to the communication: determining a need to generate a value continuum, generating the value continuum, generating a comparison of the value continuum to a value baselines comprising health metric values of a designed plan of care, and providing a representation of the comparison, and instructions, to the client to display the representation of the comparison.

### DESCRIPTION OF THE DRAWINGS

The detailed description refers to the following drawings, in which like numerals refer to like objects, and in which:

FIG. 1 illustrates an example system for determining and indicating value of health care, according to this disclosure;

FIG. 2 illustrates an example device for use in the system of FIG. 1;

FIG. 3 illustrates an example display for determining and indicating value of health care that may be used in the system of FIG. 1;

FIG. 4 illustrates another example display for determining and indicating value of health care that may be used in the system of FIG. 1;

FIGS. 5A-5D illustrate another example system, and components thereof, for determining and indicating value of health care;

FIG. 6 illustrates an example operation of the system of FIGS. 5A-5D;

FIGS. 7A-7D illustrate another example operation of the system of FIGS. 5A-5D;

FIGS. 8A-8C illustrate example displays for determining and indicating value of health care that may be generated by the system of FIGS. 5A-5D;

FIGS. 9A-9D illustrate another example operation of the system of FIGS. 5A-5D; and

FIGS. 10A-10C illustrate other example systems for determining and indicating value of health care.

### DETAILED DESCRIPTION

Large medical facilities (e.g., hospitals) may employ large, secure, and carefully regulated and monitored electronic medical record systems (EMR) (sometimes known as electronic health records (EHR) systems), and the EMR systems may use a dedicated EMR server to access a large EMR database that contains the electronic medical records. End users (for example, physicians, nurses, other health care providers, and other hospital staff) may interact with the EMR database using, for example, laptop and desktop computers, work stations, notepads, and smartphones. In some situations, end users require rapid, real-time access to the EMR database. At all times, end users require accurate and up-to-date information from the EMR system. The resulting high demand for information, conveyed in the form of requests from end user devices, and supplied in the form of responses from the EMR system, may overload the EMR system and result in slower than desired information retrieval.

For example, health care providers may lack information regarding the costs of services provided within a hospital or medical center. While health care providers (e.g., physicians) often are cognizant of their office charges and perhaps even their daily visit charges in a hospital setting, they typically do not know the hospital's costs associated with providing service to their patients. In addition, the providers usually do not know the average historical cost to treat a particular condition or the expected overall reimbursement that a health care facility may receive for patients being treated at the facility.

On the other hand, hospitals and other health care facilities may use nationally accepted formulas for each hospitalization of a patient to arrive at an expected payment/reimbursement. Additionally, hospitals generally maintain a comprehensive charge list of the costs of materials and time for each component of care delivered. Physicians and other health care providers typically lack access to these two hospital-based components of accounting, yet these components are major drivers of the cost and value of health care delivered.

Currently, there is no mechanism for combining the available accounting information from discrete information sources for all types of care, processing this information, and then presenting the information to a provider in real-time, on-demand, in a way that helps the health care provider determine an appropriate plan of care. Current methods of reporting are incomplete, inaccurate, delayed (i.e., not real-time), and/or cumbersome (e.g., information not presented in a useful, easily readable manner).

It is therefore desirable for a provider to be able to see where the cost of care of a patient falls on a cost of care continuum, from the time of diagnosis to completion of all care delivered (e.g., a final physical therapy session six months after initial medical contact). The determination of “value” has become the new mandate from businesses, payers, and the patients themselves, each of whom look to reduce health care costs. The market is ready for a system that can determine and monitor the value of health care being delivered in multiple settings from the point of diagnosis through the last service provided, whether inpatient or outpatient.

To address these issues, embodiments of this disclosure provide systems and methods for determining and indicating value of health care. The disclosed systems and methods provide and process health care cost and value information on a regular, ongoing basis, and/or on an episodic or ad hoc basis, and may automatically update the information when changes are needed or desired. A health care provider may see where the value of the patient's health care falls within a value continuum after or as a result of every input.

The disclosed systems help health care providers monitor, manage, and maximize value in the delivery of care. In some embodiments, the disclosed systems are capable of determining the average cost to treat a patient diagnosis. The systems receive information relating to a plurality of health care services associated with a patient. The systems have the ability to associate a cost with each of the health care services and the ability to aggregate the costs for the health care services. In addition, the disclosed systems are capable of presenting the service cost and value data to the health care provider in a way that it may be used to determine an appropriate plan of care for the patient.

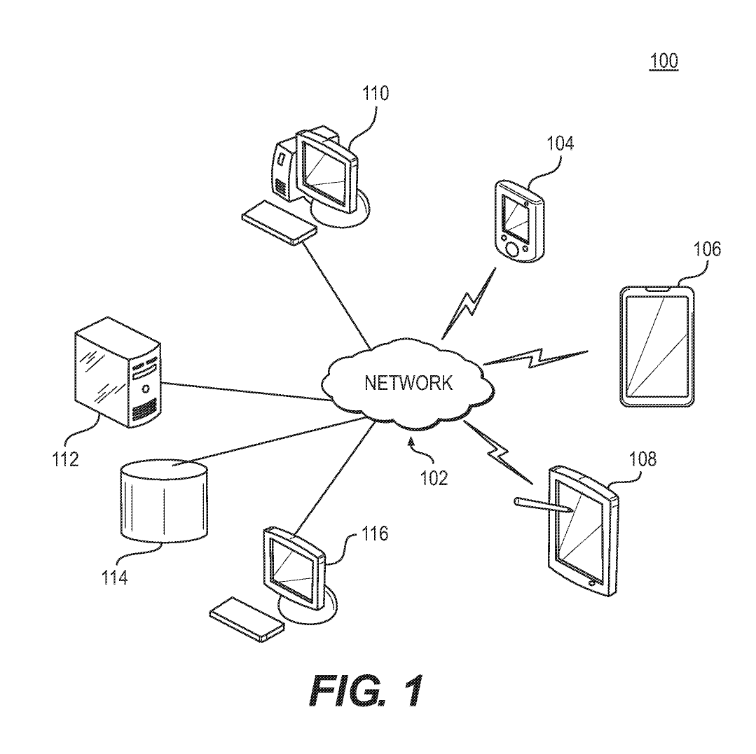

FIG. 1 illustrates an example system 100 for determining and indicating value of health care. As shown in FIG. 1, the system 100 includes a network 102. The network 102 generally represents a communication network or combination of communication networks facilitating communication between different devices or systems. Each network 102 may provide any suitable communication links, such as wired, wireless, fiber optic links, or the like. In an embodiment, the network 102 includes a combination of networks, such as the Internet, one or more cellular communication networks, and one or more local or wide area networks (which may support wired or wireless communications).

Multiple end user devices 104-110 communicate via the network 102. The user devices 104-110 generally denote devices used by health care providers or their assistants to access, provide, update, or remove information associated with patient electronic medical records (EMRs), health care costs, and health care value measurements. The user devices 104-110 include fixed or mobile devices that may communicate over wired, wireless, or other connections with at least one of the networks 102. In this example, the user devices 104-110 include a personal digital assistant 104, a smartphone 106, a tablet computer 108, and a desktop or laptop computer 110. Any other or additional user devices may be used in the system 100, and the system 100 may support interaction with any number of user devices.

One or more servers 112 also may communicate over the network 102. Each server 112 may represent a computing device that processes information associated with patient EMRs, health care costs, and value measurements, as described in greater detail below. Information associated with the operations of the server 112 is stored in one or more related databases 114. For example, each server 112 retrieves and provides information about one or more patient health care records, one or more medical or health care procedures associated with the patient, and cost or reimbursement information associated with the medical or health care procedures. Different information or additional information also may be provided by each server 112. Each server 112 includes any suitable structure for providing information and interacting with user devices. The database 114 includes any suitable structure for storing information and for facilitating retrieval of information (e.g., a relational database accessible through Structured Query Language (SQL) commands).

One or more operator stations 116 may interact with the server 112. For example, an operator station 116 allows health care personnel to access, provide, update, or remove information associated with patient EMRs, health care costs, and health care value measurements. Each operator station 116 includes any suitable structure supporting interaction with a server, such as a desktop computer, laptop computer, thin client, or mobile device.

As described herein, each user device 104-110 may execute an application or may access an application executed by the server 112. The application allows a user to interact with, receive information from, and provide information to, the server 112. For example, the server 112 may receive requests from the user devices 104-110 and in response to receiving requests from the user devices 104-110 provides information from the database 114. Other operations supported by the application are described herein.

Although FIG. 1 illustrates one example of a system 100 for determining and indicating value of health care, various changes may be made to FIG. 1. For example, various components in FIG. 1 may be combined, further subdivided, rearranged, or omitted and additional components may be added according to particular needs.

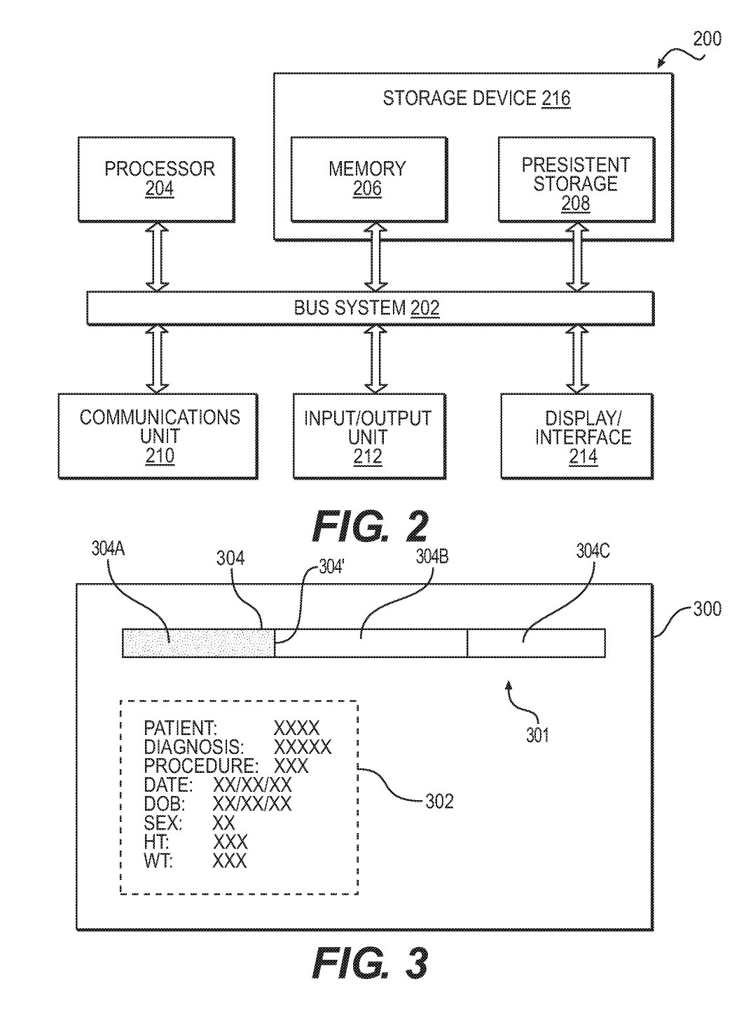

FIG. 2 illustrates an example device 200 for use in the system 100 according to this disclosure. The device 200 may represent any of the components 104-112 and 116 in FIG. 1. In this example, the device 200 includes a bus system 202. The bus system 202 supports communication between a processing device 204, a memory 206, a persistent, non-transitory storage 208, a communications unit 210, an input/output (I/O) unit 212, and a display or display interface 214. Any suitable bus system(s) 202 may also be used here.

The processing device 204 processes software/firmware instructions, such as instructions loaded from the storage 208 into the memory 206. The processing device 204 may include a single processor, multiple processors, one or more multi-processor cores, or other type(s) of processor(s) depending on the particular implementation. As an example, the processing device 204 is implemented using a number of heterogeneous processor systems in which a main processor is present with secondary processors on a single chip. As another example, the processing device 204 is a symmetric multi-processor system containing multiple processors of a same or similar type. Any suitable processing device(s) may be used.

The memory 206 and the storage 208 are examples of storage devices that may be used in the device 200. Such a storage device may be any piece of hardware capable of storing information, such as data, program code, or other suitable information on a temporary or permanent basis. The memory 206 may be a random access memory or other volatile or non-volatile storage device(s). The storage 208 contains one or more components or devices, such as a hard drive, flash memory, optical disc, or other non-transitory computer-readable storage device(s). A storage device may be fixed or removable, such as when a removable hard drive or USB thumb drive is used.

The communications unit 210 provides for communications with other systems or devices. For example, the communications unit 210 includes a network interface card or a wireless transceiver. The communications unit 210 provides communications through physical or wireless communications links.

The I/O unit 212 allows for input and output of data using other components connected to or integrated within the device 200. For example, the I/O unit 212 provides a connection for user input through a keyboard, a mouse, a microphone, or another input device. The I/O unit 212 also sends output to a display, printer, speaker, or other output device. The I/O unit 212 alternatively includes a keyboard, a mouse, a speaker, a microphone, or another input or output device(s). If the device 200 includes a display 214, the display or display interface 214 provides a mechanism to visually present information to a user. In some user devices, the display is represented as a touchscreen.

Program code for an operating system, applications, or other programs is located in the storage devices 216, which are in communication with the processing device 204 through the bus system 202. Instructions forming the programs are loaded into the memory 206 for processing by the processing device 204.

Returning to FIG. 1, a described herein, the system 100 may provide health care cost and value information on a regular, ongoing basis, or on an episodic or ad hoc basis, and may automatically update the information when changes occur. Every time a health care provider treats a patient, or otherwise orders care for a patient, the health care provider may see how the costs of his decisions relate to the overall cost objectives for a patient with a particular diagnosis. The real-time information along with robust reporting features in the system 100 advantageously provide tools to train health care providers to be more cost-conscious in making decisions about care and to provider better value in health care.

The information may be used individually (e.g., for real-time individual decision making by a health care provider) and for comparisons between providers and provider groups (e.g., using historical reporting features). For example, for an expensive procedure (e.g., a hip replacement), one provide group might include members who charge lower rates, but who use more expensive devices. This provider group may be compared against another provider group whose members charge higher rates, but who use less expensive devices. The information may be used to compare individual components of care (e.g., surgeon costs, device costs, and the like) and overall cost (e.g., the total cost for the hip replacement).

Additional details of the system 100 may be more readily understood by way of an example. For this example, consider a child who is admitted to a hospital for pneumonia. Before admission to the hospital, a health care provider (e.g., a physician) will have performed an examination and a work up of the patient (e.g., in the doctor's office, at an emergency care facility, or at another suitable location). Based on the examination, the physician has determined that hospitalization is needed for the patient. The physician writes admission orders to admit the patient to the hospital with a diagnosis of pneumonia. In addition to the pneumonia diagnosis, there may be co-morbidities. For example, the patient may have a supplemental oxygen requirement. Due to vomiting, the patient may be dehydrated and have low potassium. Thus, the primary diagnosis for the patient is acute pneumonia; secondary diagnoses are hypoxemia, dehydration, and hypokalemia.

Once a patient is admitted to a hospital or other health care facility, a clinical documentation improvement (CDI) specialist reviews the admitting physician's diagnosis, and the patient's medical history and current physical, enters the diagnoses in International Classification of Diseases (ICD) codes such as in ICD code groups ICD-9 or ICD-10, and executes a DRG grouper application to aggregate the selected ICD-9 or ICD-10 codes to produce an initial DRG code, known as a working DRG.

Estimated reimbursement information may be obtained from the working DRG. For example, the working DRG (the diagnoses determined from the medical record) may be multiplied by the relative weight of the DRG (a multiplier determined by the Centers for Medicare & Medicaid Services (CMS) that scores the severity of the DRG) and also multiplied by a “blended rate” (a CMS-determined multiplier that accounts for local cost influences including wage index of employees, percentage of indigent care provided, target populations, local salary and cost report information) to arrive at the expected reimbursement for that visit. The hospital also may maintain a “charge description master,” which is a list of all the hospital's charges and costs.

In addition to (or in lieu of) expected reimbursement information, the diagnosis (e.g., from ICD-9 or ICD-10 codes), the working DRG, or other suitable diagnosis information may also be used to obtain expected cost information. For example, an “average cost to treat” may be obtained based on a working DRG. A baseline “average cost to treat” may be determined in advance for each DRG. These baseline “average cost to treat” values may be determined empirically by examining average total costs of treatment over time at a particular facility or group of facilities, for a particular physician group, and the like. For example, an average cost to treat for an appendectomy might be determined by examining a total cost of treatment for all appendectomies at a hospital over a two-year period. In some embodiments, the average cost to treat may be determined directly from the ICD9 or ICD10 codes or other diagnosis information. In some embodiments, the average cost to treat may be determined using a neural network that includes multiple inputs, such as age, gender, ICD code(s), DRG(s), time of day, and the like.

In some embodiments, the average cost to treat may be determined based on a designed plan of care. For a particular physician group, and for a particular diagnosis, the designed plan of care may represent an authorized or approved plan of care. The designed plan of care may include components such as orders, procedures, medications, for example. The designed plan of care then may constitute, or may be used to establish, a cost to treat baseline against which the aggregated costs are compared, as described herein. The designed plan of care may be determined by a group of experts using evidence-based medicine or clinical best practices. For example, the designed plan of care may be determined by a governmental or regulatory agency, by a corporate in-house physician group, or by any other suitable organization or group. Such designed plans of care already have been developed, reviewed, and approved for strokes, pneumonia, heart attacks, chest pain, and other common medical issues, as known in the art. The designed plan of care may include an order set that also includes target times to perform each order.

In some cases, the average cost to treat for a diagnosis may be close to an expected reimbursement for the diagnosis. In other cases, the average cost to treat may vary substantially from the expected reimbursement. Where both average cost to treat and expected reimbursement are available, both information points may be valuable to the health care provider. All this information is input into the system 100 (e.g., via one or more of the devices 104-110, 116) and is associated with the patient's electronic medical record(s) (which may be stored in the database 114), as described herein.

Once a patient is admitted, various costs are aggregated based on the care ordered for or provided to the patient. For example, intravenous (IV) fluids may be ordered for the patient. There is a cost to the hospital for the fluids. There is an additional cost to the hospital for nursing care associated with setting up and administering the IV fluids. As another example, an antibiotic may be ordered for the patient. There is a cost to the hospital for the antibiotic. In addition, the hospital room in which the patient visit is associated with a cost. Each of these costs is included in a running schedule or running total of costs associated with the patient's hospital visit. In conventional systems, while these costs may be predetermined, the costs may not be readily available to a health care provider. In contrast, in the system 100, the orders for the IV fluids and antibiotic may be entered, and the effect of those costs for those items against the overall reimbursement or average cost to treat may be seen and evaluated before they are even administered.

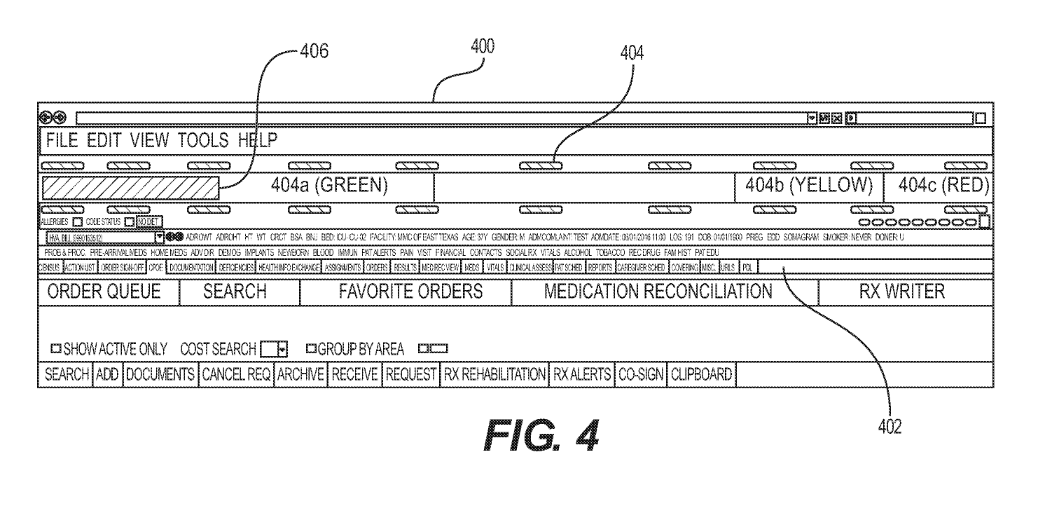

FIGS. 3 and 4 provide examples of information displays that may be useful to a health care provider. The information displays may be referred to herein as value continuums. The value continuum may include a value bar and/or a progress bar. For example, a running total of costs to treat may be indicated in the form of a progress bar across a display. FIG. 3 illustrates such a display. In FIG. 3, display 300 may represent a browser window in a web browser. The display 300 may show information 302 associated with a patient's electronic medical record (EMR). A progress bar 304 of a value continuum 301 may be shown on the display 300 along with the information 302 in the patient's EMR after the health care provider logs into the system 100. In some embodiments, the progress bar 304 is a horizontally oriented flood bar and extends across most or all the display 300 from the left side to the right side. In some embodiments, as the progress bar 304 “fills” from the left to the right, the progress bar 304 changes color regions, going from green region 304a on the left to yellow region 304b in the middle and red region 340c on the right.

The progress bar 304 may represent activity related to value continuum 301. A left (green) end of the progress bar 304 may be associated with zero cost (i.e., little or no activity related to the value continuum 301). The right (red) end of the progress bar 304 may represent the expected reimbursement or average cost to treat for the medical procedure. In effect, then, the progress bar represents progress toward reaching an expected reimbursement or average cost to treat for the medical procedure (as disclosed herein, the average cost to treat, the expected reimbursement, and hence the progress bar 304 and value continuum 301 may increase (or in some cases decrease) during a patient's visit). The green region 304a indicates that the aggregated costs of care are within the reimbursement or average cost window, and may be referred as “high value” or “premium value.” The yellow region 304b may indicate that costs are starting to approach or exceed expected reimbursement or average cost to treat (referred to as “moderate value”). The red region 304c may indicate that costs are exceeding expected reimbursement or average cost to treat, and the care may no longer be good value (referred to as “low value”). Thus, a typical (average) patient treatment plan may conclude with the aggregated costs approximately in the center of the yellow region 304b.

Each time a cost is added for the patient, the progress bar 304 may be updated to reflect the additional aggregated cost. For example, when a physician orders an antibiotic for a patient, the costs associated with that care are determined, and the effect of those costs relative to the overall reimbursement or average cost to treat may be indicated in real-time by a change in the fill level (shown in FIG. 3 as edge 304′) of the progress bar 304 on the display 300. For example, the edge 304′ of the progress bar 304 may extend further to the right (thereby resulting in a longer bar), and the color of the progress bar 304 may shift from green to yellow or from yellow to red. This change in the progress bar appearance may apply for all aggregated costs, including pharmacy, nursing, physical therapy, x-ray/imaging, bloodwork, and the like.

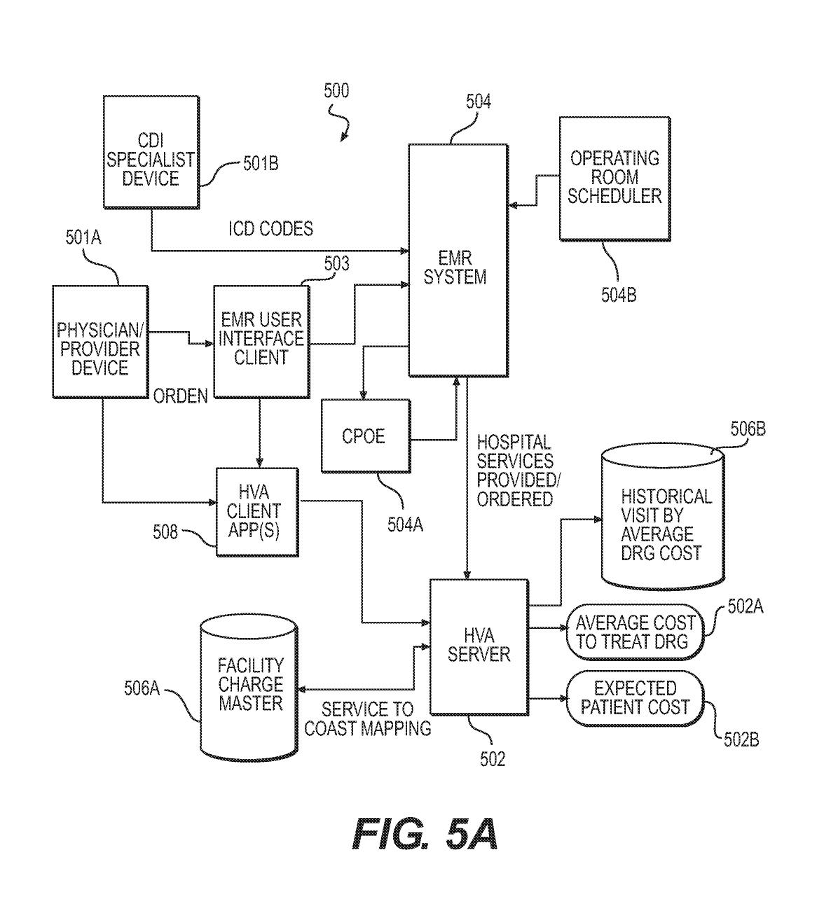

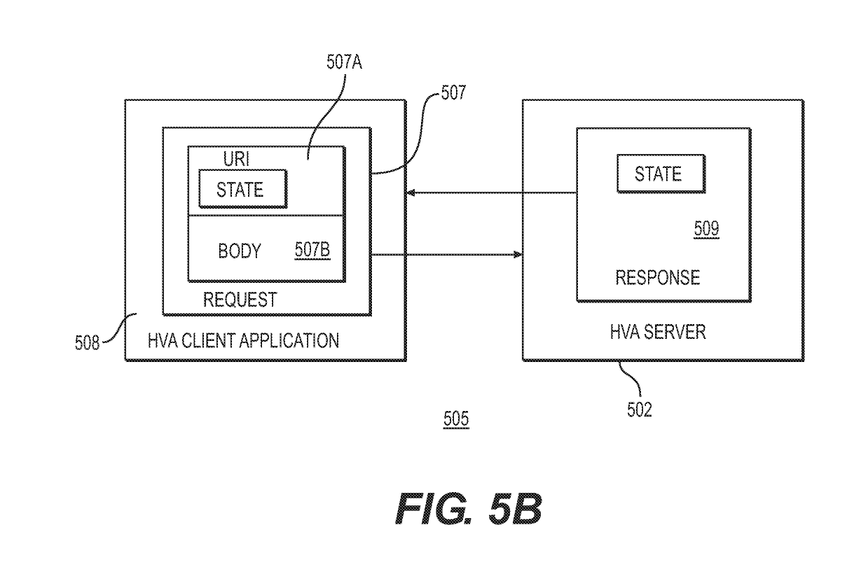

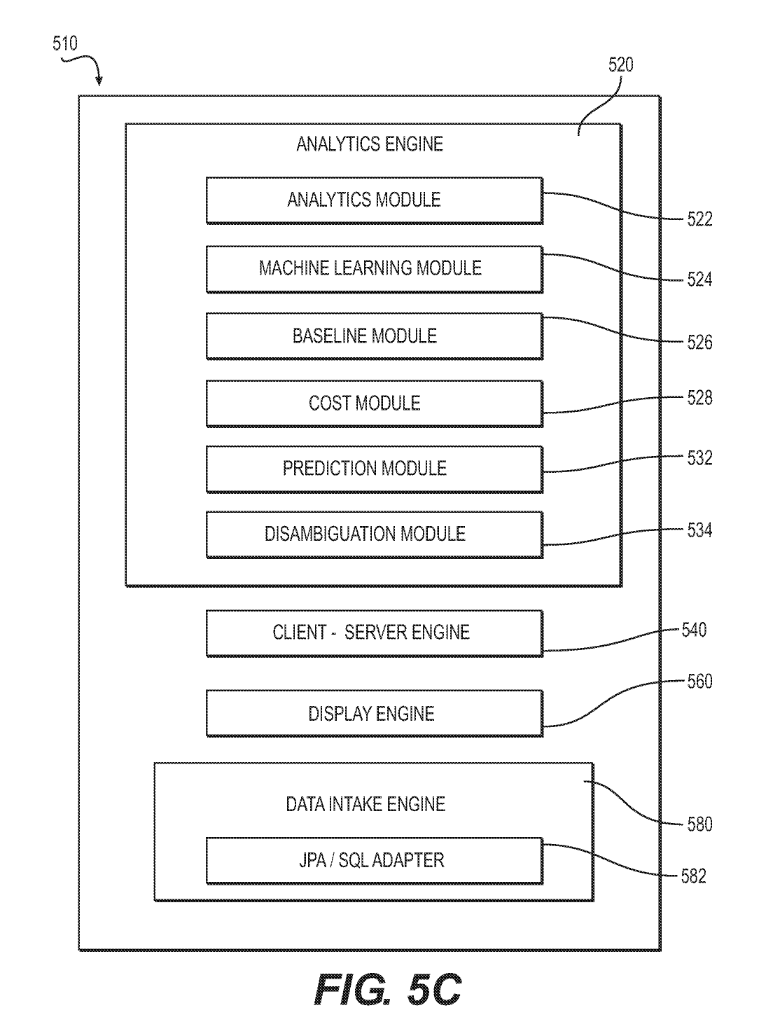

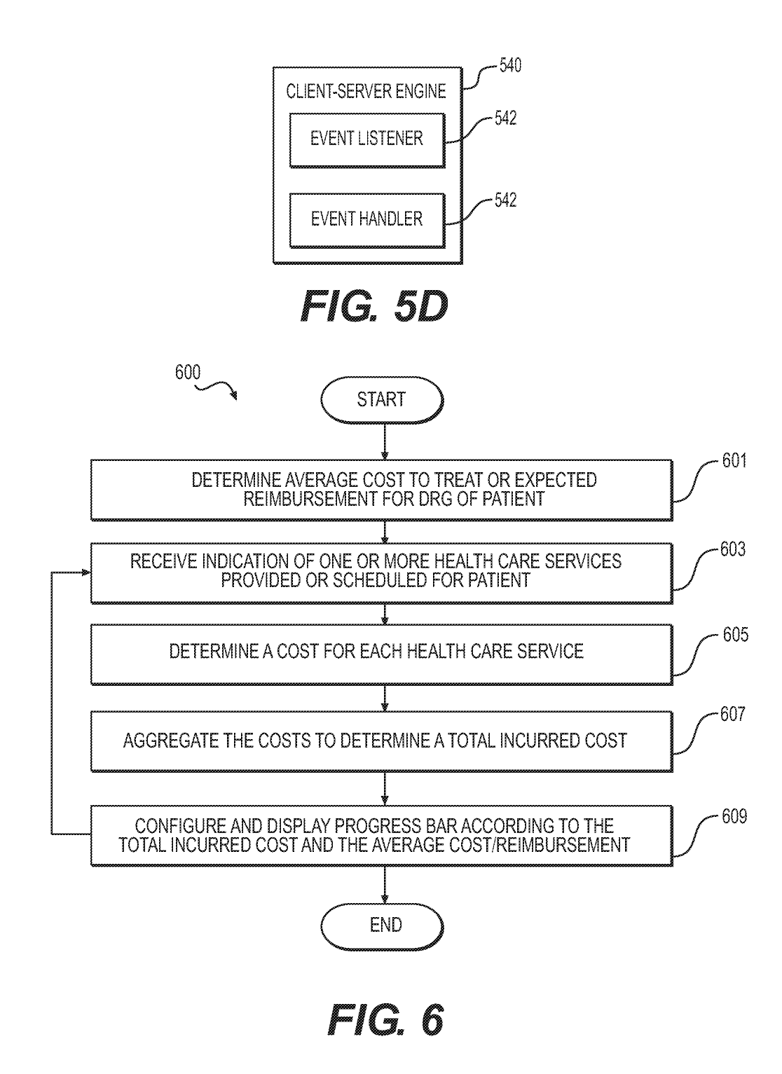

FIG. 4 illustrates another example display 400 with another example value continuum 401 and progress bar 404 that may be used in the system 100. In an aspect, he displayed progress bar 404 may represent a comparison of a value bases line and the value continuum. As shown in FIG. 4, the progress bar 404 is displayed at the top of an EMR system display 402 after the health care provider logs into the EMR. (The mechanics for displaying the value continuum and associated progress bar 404 are disclosed herein, including with respect to the descriptions of FIGS. 5A-10C.) In some embodiments, the progress bar 404 is integrated into (and is a part of) the EMR system display 402. In other embodiments, the progress bar 404 is independently generated and is in a separate (adjacent) window of the display 400 from the EMR system display 402. In some embodiments, the progress bar 404 only appears after a diagnosis is entered into the EMR system.

As shown in FIG. 4, the progress bar 404 includes three regions: a green region 404a, a yellow region 404b, and a red region 404c. The progress bar 404 also includes an indicator 406 that represents a current cost level on the progress bar 404. These regions 404a-404c may be similar to the green, yellow, and red regions of the progress bar 304 in FIG. 3. The background of the progress bar 404 may be scaled automatically based on the diagnosis. That is, the relative scale of each region 404a-404c and the cost thresholds associated with each region 404a-404c may be determined based on the diagnosis. For example, for one DRG (e.g., pneumonia), the transition from the green region 404a to the yellow region 404b might be associated with $6200 of aggregated costs, and the transition from the yellow region 404b to the red region 404c might be associated with $8100 of aggregated costs; for another DRG (e.g., heart surgery), the transition from the green region 404a to the yellow region 404b might be associated with $84,000 of aggregated costs, and the transition from the yellow region 404b to the red region 404c might be associated with $95,000 of aggregated costs.

In some embodiments, different aggregated or projected costs may affect the movement of the indicator 406 on the progress bar 404 at different times. For example, orders (e.g., cardiology, laboratory, medications, therapy consults, radiology, etc.) entered through a computerized physician order entry (CPOE) system (see for example, FIG. 5A) may register as costs immediately, thereby causing movement of the indicator 406 to the right on the progress bar 404. As another example, scheduled procedures may register as costs on the progress bar 404 when the procedure is scheduled. As still another example, room costs may update the position of the indicator 406 on the progress bar 404 at a designated time of day, e.g., at midnight when the system 100 updates room charges.

While the physician charges and costs are accrued and billed separately, facility charges and costs are typically a direct result of physician orders. These facility charges may include:
Room (base on room type, such as private or semi-private rooms, ICU, CCU, and other)—number of nights in each room type.
Pharmacy—general, supplies, IV solutions, and other.
Pharmacy administration.
Medications requiring specific identification and requiring detailed coding.
Medical and Surgical Supplies—general devices, such as oxygen, IV solutions.
Medical and Surgical Supplies—sterile devices.
Laboratory costs—chemistry, bacteriology and microbiology, and hematology.
Operating room procedures—separate from the physician charges.
Radiology—X-ray, CAT scans, other diagnostic equipment.
Transport.
Consults.

The comparison with the overall reimbursement or average cost to treat may account for different financial factors, including profit margins, “fudge factors”, differences between insurance providers, seasonal variations of costs, and the like. For example, if an average cost to treat a particular diagnosis is $5000, but it is known that certain costs increase by approximately 10% during a particular time of year, the average cost to treat may be adjusted to $5500 before it is used as the target in the progress bar 404. Such adjustments may be made in a cost database, e.g., by a facility accountant or system administrator.

In some embodiments, the progress bar 404 may reflect an anticipated cost at discharge. The anticipated cost at discharge may be determined based on a number of factors, such as how long the patient has been admitted, the DRG, ICD-9 or ICD-10 codes, the costs aggregated up to a current point in time, and the like. Once determined, the anticipated cost at discharge may be displayed on or with the progress bar 404. The anticipate cost at discharge may serve as a “look ahead” feature that allows a health care provider to compare a current patient's costs against cost trends from similar patients to show how the current patient costs are tracking.

In some embodiments, the average length of a visit for a procedure is also presented on the display 400, e.g., in proximity to the progress bar 404. The displayed average length of visit for a DRG may be used by the health care provider, along with the progress bar 404, to help the health care provider plan the patient care. For example, the average length of visit gives the health care provider an estimated endpoint of care, so that the health care provider may start to generate a discharge plan, consider or schedule resources (rooms, nurses, etc.), and the like. Also, the estimated length of a visit may influence the health care provider's decisions on care. For example, if an average length of a visit for an appendectomy is one night, and a particular health care provider regularly keeps patients with the same diagnosis for two nights, the health care provider may consider a change his plan of care if the provider sees on the display 400 that the average visit is one night and his standard care plan is outside the norm.

The system 100 may be used for cost comparisons. For example, if a patient experiences respiratory problems while in the hospital, the health care provider may determine that an x-ray or computerized axial tomography (CAT) scan is needed. The health care provider may provisionally enter an order for an x-ray on the display 400 and then view the movement of the progress bar 404 to see how the x-ray affects the overall value continuum. The health care provider may then provisionally enter an order for a CAT scan and then view the movement of the progress bar 404 to see how the CAT scan affects the overall value continuum. Because the cost of a CAT scan is so much higher than the cost of an x-ray, it is likely that the progress bar 404 would move closer to red due to the CAT scan than it would due to an x-ray. By comparing the movement of the progress bar 404 for each test before the test is ordered, the health care provider may better understand the financial impact of each test or order on the patient's treatment plan.

The system 100 also may be used in early decision making by the health care provider. Consider that a health care provider creates an order that may have some cost variability. For example, an order for physical therapy may have widely varying costs, depending on the number of sessions, the progress of the therapy, the condition of the patient, and the like. In some embodiments, the system 100 may be configured to display an estimated reimbursement or an estimated average cost for the order based on the diagnosis before the order is finalized. The estimated reimbursement or average cost may be displayed in the system 100 in real time while the order is being filled to give the health care provider an indication of what an order will cost. The health care provider then may use those estimates in his decision making. As the order is filled and actual costs are incurred, the costs may be compared to the estimated average cost or reimbursement. In some embodiments, the actual costs also may be used to update the estimate for later procedures. Scheduled procedures may be handled in a similar manner. The cost for a scheduled procedure may be estimated at the time the procedure is scheduled based on a historical average cost to perform the procedure on patients with the same diagnosis. In situations where a DRG is not available, ICD-9 or ICD-10 codes may be used, or an estimated cost for a procedure may be determined based on costs for the procedure across an entire patient population or the average cost for the physician performing the procedure based on having performed the same procedure in the past.

In some embodiments, the process and metrics will be driven by the physician, since the physician is the health care provider who admits patients. The physician may have an overall value metric assigned to him. The overall value metric may be based on an aggregation of overall value continuums for a plurality (e.g., some, most, or all) of the medical visits, procedures, or diagnoses for which the physician is the attending health care provider. In other embodiments, health care providers other than a physician may admit the patient.

A specialist health care provider who provides services during a procedure (e.g., an anesthesiologist during a surgery) may bill separately for his professional services; thus, the fee for the specialist may not be included in the overall value continuum for a procedure. However, the resources of the facility that are used by the specialist may affect the overall value continuum. For example, one anesthesiologist may require multiple attempts to intubate, or may keep patients on a ventilator longer than other anesthesiologists, or may use more expensive anesthesia or in greater quantities than other anesthesiologists. Those costs will be incurred by the facility and will affect the overall value continuum for that procedure.

In some embodiments, consultations with other health care providers (e.g., other physicians, such as specialists) may be included in the determination of value, as shown in the value continuum and corresponding progress bar 304. Each health care provider may have an overall value metric assigned to him. When a health care provider in charge prepares to consult another health care provider, the health care provider in charge may review the overall value metric associated with the consultant to determine if the consultant represents a good value. By examining value metrics for multiple consultants, the health care provider in charge may determine which consultant represents the best value.

The system 100 may include one or more reporting applications or modules for reporting on value continuums. Reporting may be available to determine an overall value of each cost center (e.g., pharmacy, nurse, physician, caregiver in charge, consultant caregiver, lab, and the like) based on different parameters. The data in the reports may be grouped for a particular period; for a particular type of procedure, hospitalization, or diagnosis; for a particular clinic or hospital in a multi-facility hospital chain; or for any other parameter or combination of parameters. For example, reporting features may allow a user to review the overall value for all internal medicine physicians who treated pneumonia between March and September at Hospital A. The data may be broken out by physician or the data may be grouped for the physician group. Grouped data may be selected and a “drill-down” option may be applied to see more specific data. For example, grouped data may show that a physician has a value metric for a six-month period for pneumonia patients. However, a drill down on the grouped data may indicate that the physician had high value for all patients in the six-month period except for one patient with special circumstances, which brought the physician's average value metric down. Trend reporting allows a user to review the value of a physician or other care provider at different points in time over a period.

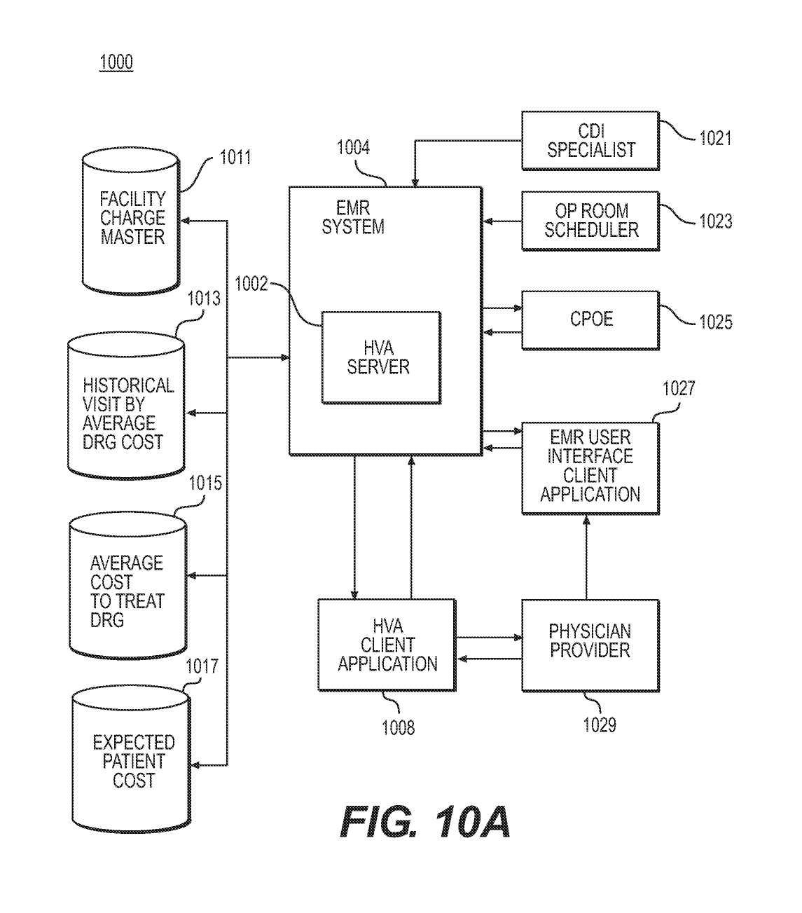

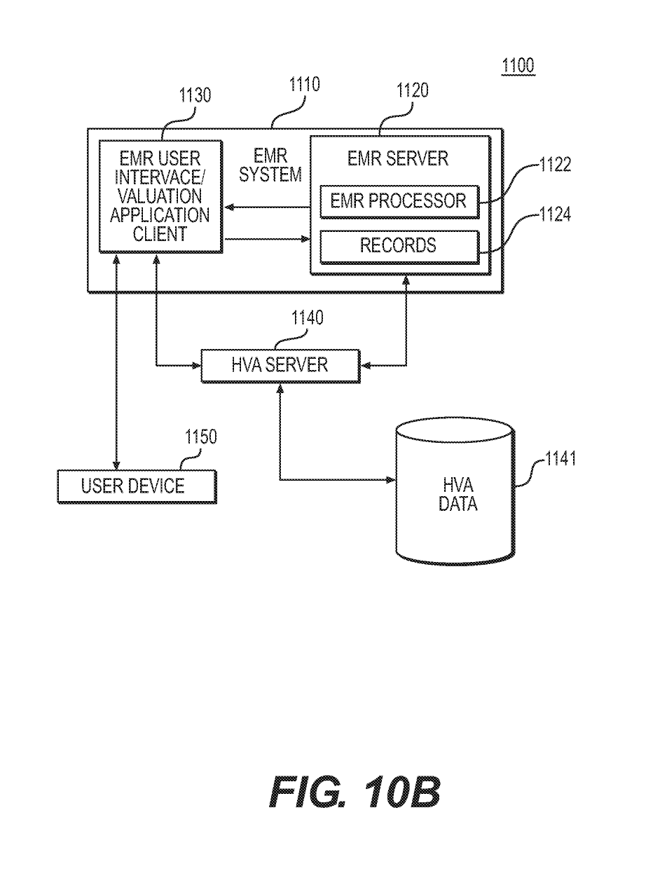

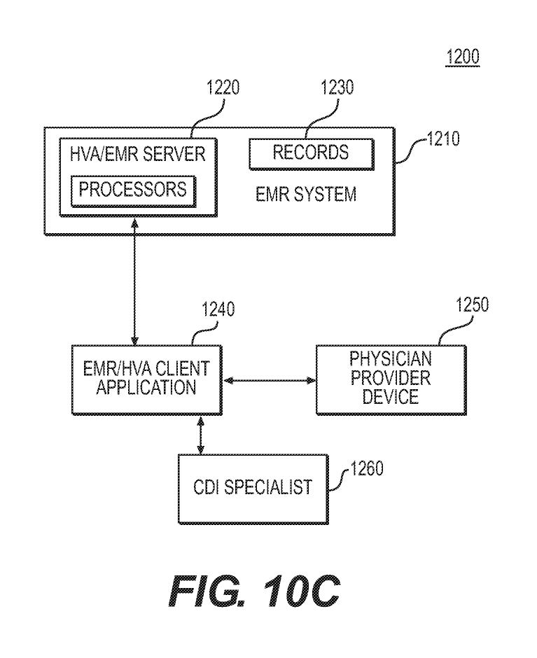

FIG. 5A illustrates another example system 500 for determining and indicating value of health care. One or more components of the system 500 may represent, or be represented by, one or more components of the system 100 of FIG. 1. The system 500 includes a Health Value Analytics (HVA) server 502, an EMR system 504, a facility charge master data source 506, and one or more HVA client applications 508. The EMR system 504 includes a server and records store (not shown). The system 500 further includes computerized physician order entry (CPOE) module 504A, operating room scheduler 504B, EMR user interface client 503, and data source 506B (historical visit by average DRG cost). The HVA server 502 produces average cost to treat DRG 502A and expected patient cost 502B. The EMR system 504 may be accessed and used by health care providers such as a physician provider at physician provider device 501A and hospital staff, such as a CDI specialist, at CDI device 501B. In an embodiment, a physician provider or CDI specialist may access the devices 501A and 501B, respectively, using, for example, a personal data assistant or other devices such as the end user devices 104-110 of FIG. 1 through a virtual private network (VPN) (not shown), for example. In an embodiment, some components of system 500 may be software programs instantiated on system 500 hardware components. For example, COPE module 504A may be a software module resident on a component of EMR system 504. In this example, a physician may access EMR user interface client 503 and invoke CPOE module 504A to enter patient orders. In an embodiment, the components of the system 500 may be behind a firewall such that communications between and among the components are simplified, and communications security is enhanced. In an aspect, the EMR system 504, devices 501A and 501B, CPOE 504A and operating room scheduler 504B, and EMR user interface client 503 may be components of a legacy hospital system while the HVA server 502 and HVA client application 508, and associated data stores 502A, B, and 506A, B, may be added to, integrated with, or simply in communication with the legacy hospital system. FIGS. 10A-10C provide alternate arrangements of the components of FIG. 5A.

The HVA server 502 may be a back-end server (similar to the server 112 of FIG. 1) that connects (via a network connection) to the EMR system 504 for the hospital system or group where the system 500 is installed. The system 500 may work with any EMR system 504. In some embodiments, sensitive patient or provider information is not stored in the HVA server 502, such as names, addresses, phone numbers, Social Security numbers, and personal credit card numbers or other financial data. In some embodiments, the HVA server 502 receives order information, patient information, and the like from the EMR system 504 by executing SQL commands to retrieve the information from the EMR system 504 database. In other embodiments, the HVA server 502 receives order information, patient information, and the like from the EMR system 504 by, for example, an HL7 interface to the EMR system 504.

The facility charge master data source 506A is a database, data table, or other data source that includes charge information for a hospital or other facility. The HVA server 502 stores or is able to access the charge information from the facility charge master data source 506A, and uses the information from the data source 506 to convert orders received from the EMR system 504 to one or more costs. In some embodiments, the facility charge master data source 506A may be received by the HVA server 502 as a file (e.g., via email). The file may then be loaded into the HVA server 502. Alternately, the HVA server 502 may connect directly to the hospital or facility accounting system to retrieve these charges. Ultimately, it is hospital or facility costs that are used in the system 500; these may be determined simply by multiplying a cost-to-charge ratio factor by the charges or have a table or method of calculating costs from the orders.

The EMR user interface client 503 may be implemented as software or hardware. In an aspect, the EMR user interface client 503 is accessed by physician provider device 501A to connect to the EMR system 504 and, by way of HVA client application 508, the HVA server 502.

The HVA server 502 connects to a hospital or facility contracting system to obtain accurate cost data based upon admitting diagnosis codes or DRG codes when they become available. Alternatively, the HVA server 502 may calculate the cost data itself, either from a statistical model fit to historical data or from a DRG cost calculator. If the HVA server 502 performs the calculations, then factors, rates, and formulae may be stored in the HVA server 502 for easy access. If a statistical model is used, then the HVA server 502 may act upon patient symptoms or diagnosis codes for input to the model.

The HVA server 502 may be configured with one or more data stores for use by the system 500 to support model development and displays. Such data that the system 500 supports includes:
DRG average reimbursement amounts based on diagnoses, including blended rate multipliers, and other factors. This means that ICD codes are interpreted to produce the expected average reimbursement amounts.
Facility costs associated with any order that is possible for a patient. Historical data may be maintained within the system for model development, and up-to-date data may be continually updated to provide the most recent costs pertaining to the physician orders. These include: supplies (drugs, IV fluids, oxygen, and the like), producing X-rays, CAT scans, and lab work, cost of nursing care, and room charges with time increments for all types of rooms.
Any data from a facility accounting system that may help with actual reimbursements, order costs and schedule costs.

Each HVA client application 508 may be accessed on a client device or end-user device with a display (such as one of the end user devices 104-110 of FIG. 1) and provides functionality for users of the system 500 to see and check on the value continuum of care while a patient is in the hospital or facility over an admitting period (e.g., during a visit in which the patient is admitted). Each HVA client application 508 may exchange information with the HVA server 502 over a secure network link via one or more custom APIs.

Each HVA client application 508 may be installed on a client device (such as the EMR user interface client 503 or one of the end user devices 104-110 of FIG. 1) as a stand-alone application or as a plug-in. Additionally, or alternatively, each HVA client application 508 may reside on another central device (e.g., the HVA server 502) and be accessed by a client device via a portal such as a web browser.

In an embodiment, the HVA client application 508 and the HVA server 502 communicate using a stateless transfer architecture and protocol, a part of which is shown logically in FIG. 5B as architecture 505. The HVA client application 508 may make many requests to HVA server 502. One advantage of the stateless transfer architecture 505 is that requests, such as request 507, from the HVA client application 508 to the HVA server 502 include (i.e., within the request itself) the necessary state information to allow the HVA server 502 to respond properly to the requests. After the HVA server 502 has completed its processing, the appropriate state is communicated back to the HVA client application 508 in response 509. In this regard, “state” refers to data required to fulfil or respond to, the request 507. “State” is data that varies by patient, physician, and other entities, and by diagnosis and other factors and considerations. Thus, “state” refers to data in, for example, EMR system 504, or data resident on the HVA server 502. As a further example, “state” may refer to authentication information passed from the HVA client application 508 to the HVA server 502. The request 507 is seen to include a URI 507A as well as a body 507B. The necessary state information may be contained within the URI 507A. The URI 507A uniquely identifies the source (HVA client application 508) and the state, or state change, of the HVA client application 508. The state information also may be included in a header or in the body 507B. This architecture 505, therefore, eliminates the concept of a “session,” where the HVA server 502 would be required to maintain, update, and communicate session state. Thus, the HVA server 502 operates more efficiently, and load balancing is less of a concern with the “stateless” nature of the architecture 505. Use of the architecture 505 also reduces problems with “lost” data and responses when the HVA client application 508 is implemented as a browser plug-in.

FIG. 5C illustrates an example program of instructions executable by processors resident in or accessible by the HVA client application 508 and the HVA server 502. In FIG. 5C, program 510 includes components (modules, engines, data) may be distributed between and among HVA client applications 508, the HVA server 502, and other workstations and processing and data storage devices, including those shown in the example system 500 of FIG. 5A. Moreover, the example program 510 shown in FIG. 5C is for illustration purposes, and the various components of the program 510 may be combined or separated. The program 510 includes analytics engine 520, client-server engine 540, display engine 560, and data intake engine 580. The analytics engine 520 includes analytics module 522, which includes analytics models, machine learning module 524, baseline module 526, cost module 528, which includes cost models, predictor module 532, and disambiguation module 534. The client-server engine 540, in an embodiment, employs the stateless transfer architecture 505 of FIG. 5B to allow efficient, accurate communications (requests and responses) between the HVA client application 508 and the HVA server 502. The client-server engine 540 is shown in more detail in FIG. 5D. The display engine 560 includes display drivers to display the progress bar and other data. The data intake engine 580 includes JPA/SQL adapter module 582 and an HVAAnalytics.jar executable to allow communications and data transfer between the HVA server 502 and the EMR system 504.

The HVA server 502, in cooperation with the HVA client application 508, and other components of the system 500 of FIG. 5A, executes components of the program 510 to display interfaces such as the displays of FIGS. 3, 4, and 8A-8C.

The HVA Server 502 also executes the program 510 to develop or use specific models, to populate specific data stores, to analyze data using the models, and to interact with the HVA client application 508 and the EMR system 504. For example, the program 510 is executed to compute Measured Cost, which is a cost basis used to compare against a Baseline Cost. The Baseline Cost is derived from application of analytics models and cost models and various methods of the analytics engine 520. For example, an estimate and correct method may be used to derive the Measured Cost, such that any time actual costs to treat a patient exceed estimated costs to treat the patient, the actual cost to treat the patient is used in lieu of the estimated cost to treat according to: Measured Cost=max (Sum(Orders), Sum(Actuals)). To derive Sum(Orders) for every ordered/scheduled event the, the analytics engine 520 may be accessed to apply the following logic: for events that have a cost based on variables not known at the time of order, the cost will be estimated using a method defined in the analytics engine 520 (average cost from the analytics models) to approximate the following variables: Procedures: the measured cost=max (estimate for procedure, actuals for procedure); Therapies: the measure cost=estimated for therapies; Quantities (PRN): assume quantity=1; and Time: the maximum time duration is assumed. Total Cost is derived by comparing the Measured Cost against the Benchmark Cost for the diagnosis. Predicted Cost is derived by comparing the Measured Cost against the Expected Costs (from the analytics models) for the diagnosis and current length of treatment. Category Cost Totals are derived from partitioning the Measured Cost using a defined mapping based on revenue codes (from the analytics models: for example, Radiology, Lab, Procedure, Therapy, Pharma, Room, Other). Order Totals are derived from partitioning (disambiguating) the Measured Cost using charge codes and including a frequency metric (from the analytics models) for the diagnosis. In an example, the HVA Cost Model has five components, which may be .csv files that have formats and use data specified as follows. charge_codes.csv; PharmaNDCCodeCosts.csv; ChargeCodeCosts.csv; DRGAdjustedAverageCosts.csv; and category_thresholds.csv. The first three files may be applied to charge codes that are assigned to individual patient visits, the DRGAdjustedAverageCosts.csv file is referred to as the Baseline Cost, from which savings may be compared. The category_thresholds.csv file partitions or disambiguates the Baseline Costs into seven individual categories by DRG: Room, Lab, Procedure, Pharma, Therapy, Radiology, and Other.

To build the Baseline Costs, the HVA analytics engine 520 may execute instructions of the data intake engine 580 to access data from the EMR system 504. For example, the HVA analytics engine 520 populates a number of tables in a local data store, including Populate the hospital_pharma_costs table. This process involves reading data directly from the EMR system 504. The first step involves running valuation program HVAAnalytics, which may be a .jar executable, for example) on the HVA analytics engine 520 using the flag: processARangeOfEMRIntakes=true to produce a very large file, PharmaExportData.csv. This very large file includes any corrections for pharma charge codes seen in the EMR database. This file may be exported and uploaded into the hospital_pharma_costs table using the command:
LOAD DATA INFILE ‘/disk2/ipx/Hospital/PharmaExportData.csv’
   INTO TABLE hospital_pharma_costs
   FIELDS TERMINATED BY ‘,’ OPTIONALLY ENCLOSED BY “ ”
   IGNORE 1 LINES;
      The next step is to populate a hospital_pharma_intakes tables by executing the THCICDataAnalytics.jar program with the following flags: readlnHospitalPatientIntakesData=true; readlnHospitalCostToChargesData=true. Step 3: Populate the charge_code and pharma_NDC_code tables. This step is performed using the THCICDataAnalytics.jar program with the following flags: refreshChargeCodesFromDB=true; refreshPharmaCodesFromDB=true. When the program completes, the HVA analytics engine 520 dumps the contents of the charge_codes and pharma_NDC_code tables to comma-separated files: ChargeCodeCosts.csv and PharmaNDCCodeCosts.csv, respectively. The HVA analytics 520 does this by running SELECT*FROM charge_codes WHERE 1. The HVA analytics engine 520 uses a comma-separated file (.csv) format to export the results from this query to a flat file named ChargeCodeCosts.csv.

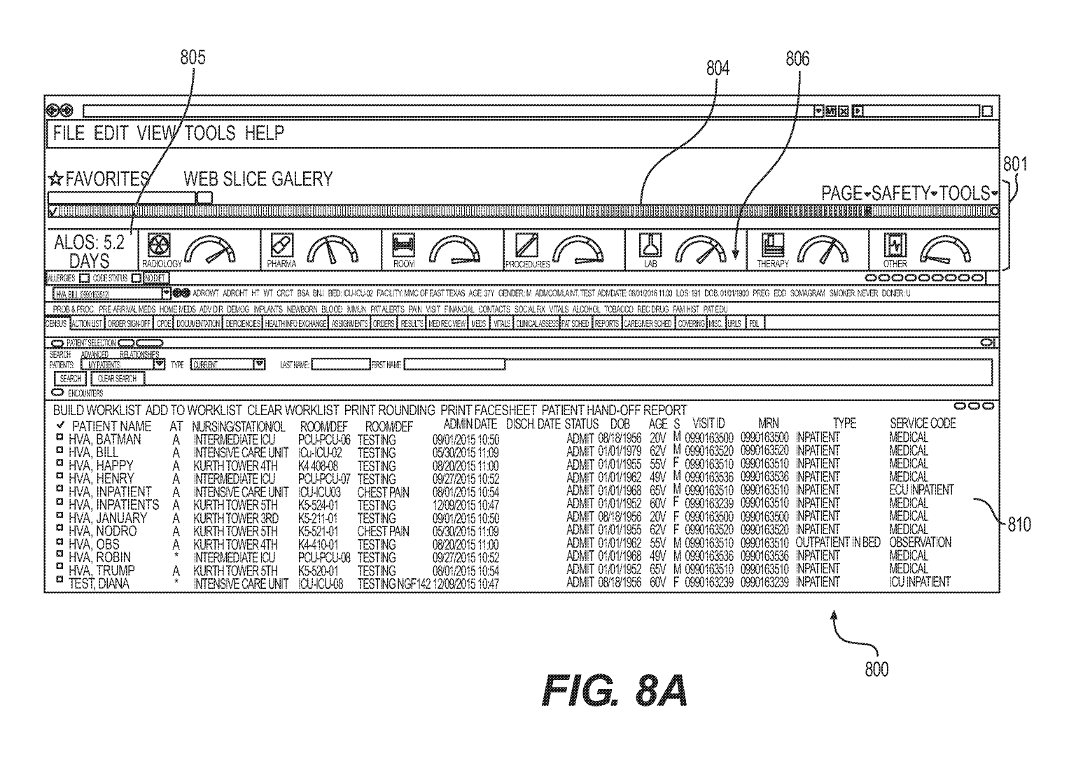

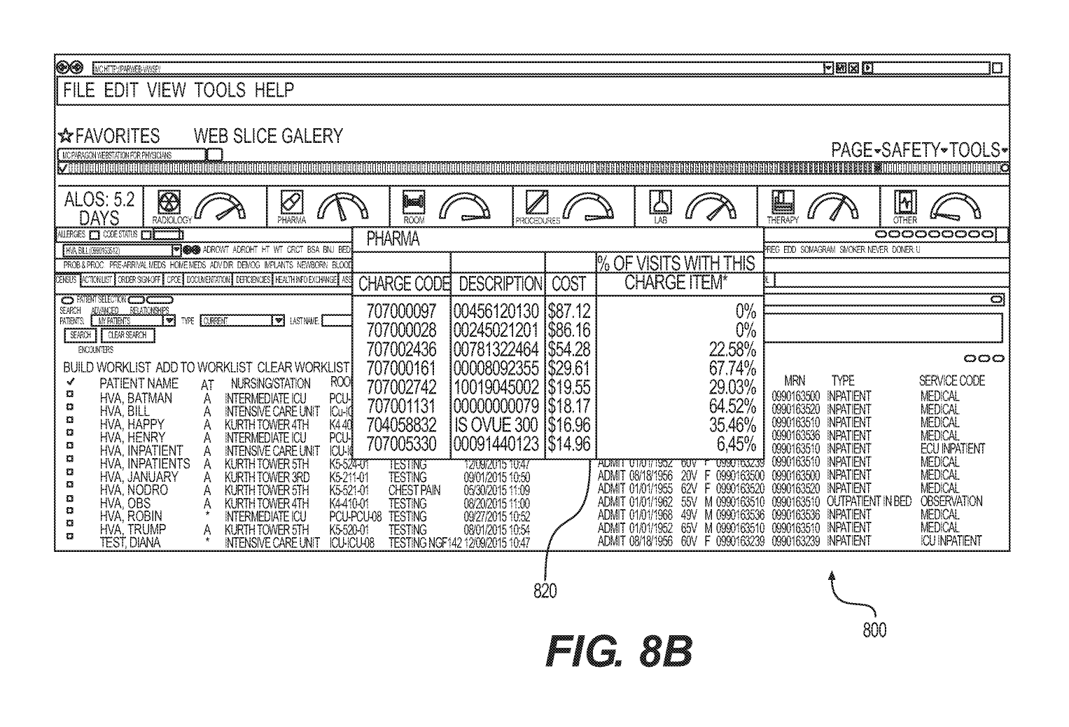

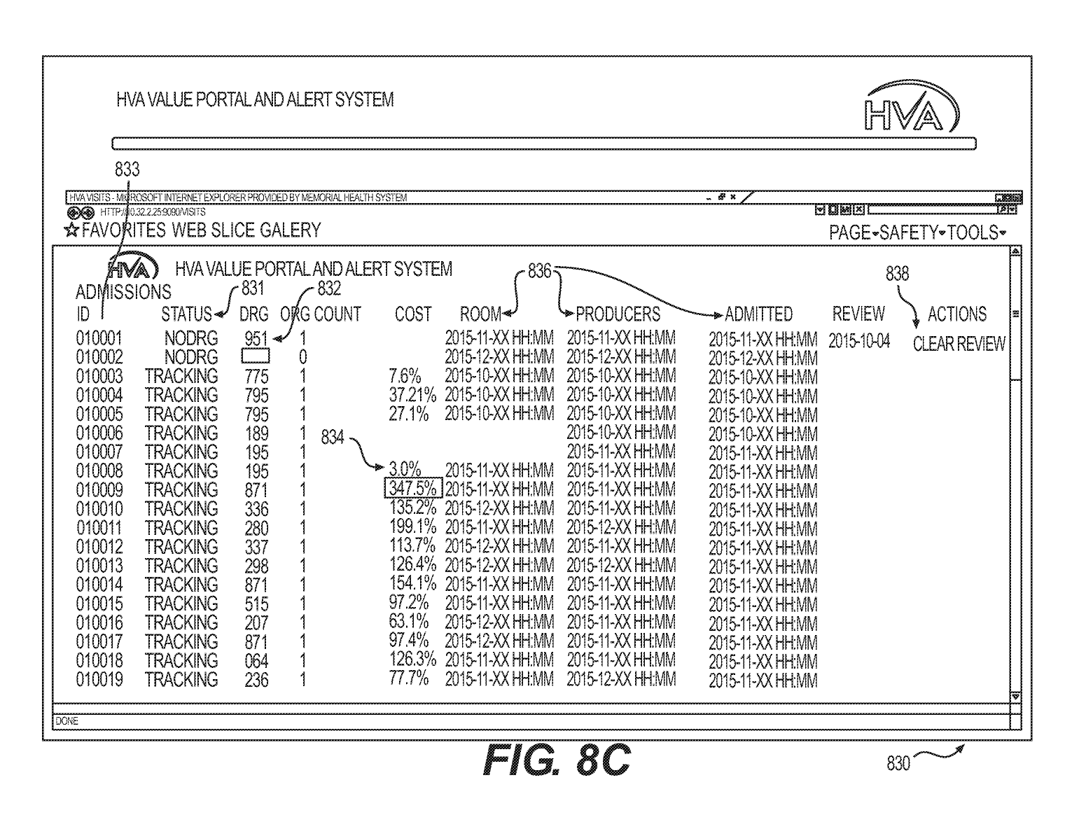

In an embodiment, the HVA client application 508 enables a display that is the same as or similar to the display 300 of FIG. 3, the display 400 of FIG. 4, or the displays of FIGS. 8A-8C. The display may include one or more of the following features:
A progress bar (e.g., the progress bar 304, 404, 804) that compares actual and scheduled costs aggregated by the hospital or facility against the average cost expected for care delivered or expected reimbursement based upon the admitting diagnosis or DRG codes. The progress bar may include three primary colors—Green means that the value of care is good and well within the limits expected for the average costs based on the working DRG (“premium value,” e.g., less than 85% of average cost), yellow indicates that costs are starting to approach or exceed average costs (“moderate value”), and red indicates that the value of care is poor with recognized cost overruns (“low value,” e.g., at least 115% of average cost).
Specific details that define how the progress bar is to be displayed including flood percentage and color information may be stored at the HVA server 502 and may be configurable by a user or a system administrator.
The user may click on or hover over the progress bar, which brings up additional information about the patient or about costs associated with the patient. The type of additional information that may be displayed includes but is not limited to:
   Average length of visit
   Aggregated cost of laboratory orders as compared to the average cost of laboratory orders
   Aggregated cost of radiology orders as compared to the average cost of radiology orders
   Aggregated cost for procedures as compared to the average cost of procedures
   Aggregated cost for medications ordered as compared to the average cost of medications ordered
   Aggregated cost of room charges as compared to the average cost of room charges
   Aggregated cost of therapy orders as compared to the average cost of therapy orders
   A detailed list of all the discrete orders and the associated costs for each order.
The type of additional information and the way the additional information appears are configurable by a user or a system administrator.
The HVA client application 508 may interface with EMR system 504 or an order system that the physician uses to connect to the EMR system 504 (e.g., CPOE module 504A) as a patient's treatment plan is updated, so that real-time updates may be sent to and from the EMR system 504 and the user may see these updates at the HVA client application 508 as the updates occur.
Information to populate the value continuum and the progress bar in the HVA client application 508 is provided by the HVA server 502. Calculations and display information may be controlled at the HVA server 502 or may be performed by a client device.
Security features support secure access to the HVA client application 508. For example, access to the HVA client application 508 may be granted only after a user provides a suitable user ID and password. In some embodiments, a system administrator may access a security maintenance application on the HVA server 502 to provide authorization for a user to access the HVA client application 508 and see content. Since the progress bar may be displayed as part of a patient EMR view, the HVA client application 508 may infer user privileges based on corresponding user privileges in the EMR system 504. In some embodiments, the HVA client application 508 will only display the value continuum and the corresponding progress bar if the user is a physician of record for the patient being viewed.

The system 500 operates in real-time or nearly real-time, such that changes to data in various components of the system 500 may be reflected in other components concurrently or within a short period after the change. For example, whenever data from the EMR system 504 for a patient record that is currently on display at the HVA client application 508 is updated with new information relating to either the DRG or the orders/costs associated with the patient, the system 500 becomes aware of the data changes within a short period (e.g., 15 seconds) of the change and presents updated HVA value content on the display of the HVA client application 508. Example mechanisms to “make the system 500 aware” are disclosed herein, including with respect to the description of FIG. 5D.

Components of the system 500 may monitor changes in the treatment plans by periodically comparing the latest measured values against the baselines. The components may use configurable threshold ranges to define notification events that may be sent to a subscribing endpoint (by, for example email, message queues, http, etc.). Example endpoints shown in the system 500 of FIG. 5A include an account of physician provider (who may access the account using the EMR user interface client 503).

To provide an alerting function (such as display 830 of FIG. 8C), value continuum updating in real time, and reduce bandwidth demand on the network of FIG. 5A (the network being the connections between and among the components of system 500, and in particular, the connections between and among the EMR user interface client 503, HVA client application 508, HVA server 502, and EMR system 504), queries, requests, and demands on the EMR system 504 database, and general computational load on the EMR system 504, may be handled in such a way that some activity by a physician/healthcare professional (the physician provider) may be handled before the HVA client application 508 is able to request an update to the value bar. In an aspect, the required “activity” may be a browser event, such as clicking on the value bar, for example. Such browser activity may be detected by an event listener and the resulting action may be invoked through operation of an event handler. Such event listener and event handler are disclosed here, for example, with respect to FIG. 5D.

FIG. 5D illustrates an example client server engine 540. As can be seen, the engine 540 includes event listener 542 and event handler 544. To improve network traffic efficiency, the EMR user interface client 503 uses the event listener 542 to detect an activity indicative of an appropriate browser event, such as navigate, refresh, etc. In one example, the physician provider using the device 501A may log in to the system 500 (i.e., may operate the EMR user interface client 503, access the CPOE module 504A, and enter an order for a newly-admitted patient). The HVA client application 508, invoking event listener 542, identifies the log-in and order entry as activity that calls for creation of a value continuum and corresponding progress bar, and sends a request 507 to the HVA server 502, which in turn executes instructions to create and display the value continuum and the corresponding progress bar. In a second example, when a link is clicked-on or the browser is refreshed, the client 503 validates that the URL is the correct address of the EMR system 504. Aspects of this second example include the event listener 542 detecting the click on, or navigate, to another page or to another URL as an activity or event that may require recomputation of the cost to treat that is reflected in the value continuum and expressed by the progress bar. However, not all click-on detections result in a need to recompute the cost to treat. The event handler 544 may account for such events by invoking a “minimal request” process. For example, as the client 503 is navigated through the EMR system 504, with the same patient selected, on each event the client 503 may use a minimal request to the HVA server 502 asking for an update to the cost value. If the value returned is the same as the current value, no further network transmissions are performed until another browser event is detected. If the cost values differ, then the client 503 may request an update for the rest of the patient information such as DRG, DRG description, detailed cost breakdown, etc. However, the request is only for data that has changed. In this method, the network utilization of the client device is tied to comparing the currently stored cost on the client side with an updated cost on the server side. Furthermore, in a scenario where the client side EMR is using a web browser and hosts the EMR system 504 at a specific URL, the HVA client application 508 may compare the current URL being viewed by the user to the EMR system 504 host URL to determine if it is appropriate to both display and populate (request patient information from the HVA server 502) the value continuum and progress bar. For example; while a user is viewing a patient, in the EMR system 504 via a web browser, who has a valid working DRG, the user will see a populated value continuum. But if that user navigates to www.xxxxx.com, the HVA client application 508 may recognize the new URL as an invalid URL; i.e., not a URL that is used to host the browser based EMR system 504. Therefore, the HVA client application 508 will no longer display the value continuum and progress bar, nor will the HVA client application 508 make any further requests to the HVA server 502 nor create any more network traffic. In a browser-based EMR system, the URL that hosts the EMR system may be hard coded in the HVA client application 508. While accessing the EMR system 504, a user may navigate through many links to get different information e.g., create a new order for a patient, see the fulfillment of standing orders, see documentation of a patient, see allergy information of a patient, etc. Clicking in any of these links would initiate a navigation event. Either the user (through a user device, for example) or the EMR system 504 itself may initiate a navigation or refresh event. In an example instantiation of the EMR system 504, the EMR client application 508 may uses iframes, and the HAV client application 508 may detect any navigation event, whether the user navigates to a completely new URL, or the user navigates to a new frame that is within the EMR system 504 URL. A minimal request may be a GET request sent to the HVA server 502 to retrieve current cost value for a patient using only the necessary information to be sent to the HVA server 502 to fulfill the request to get the current running cost of the patient. In an aspect, HVA client application 508 analyzes events that are detectable on the client side without utilizing any network resources. To perform a similar analysis on the server side, the HVA server 502 would have to constantly poll the client side for new event information, which would use more network bandwidth. As noted herein, network utilization is at a premium in a hospital's network. Therefore, in the system 500, the HVA server 502 acts as a slave to requests from the HVA client application 508, and the HVA server 502 is able to efficiently deliver value and cost details at the request of the HVA client application 508. The notion of using event listeners/handlers in the HVA client is useful in systems that use a browser-based EMR interface. In other scenarios, the HVA client application 508 may use screen captures and analyze text to validate and distinguish update events of standalone EMR software.

In some embodiments, when the HVA client application 508 displays comparison data (i.e., the value continuum and the corresponding progress bar) for a patient, the HVA client application 508 may display data comparisons in one of several different modes. The activity surrounding the patient during a displayed admission cycle may cause the progress bar to move from green to yellow to red. The user may select the type of comparison the user wishes to see, including:
Actual and scheduled charges compared to the average cost to treat for the facility.
The actual and scheduled charges compared against a peer group of physicians treating similar patients. The patients may be categorized as similar based on the patients having the same diagnoses codes (e.g., DRGs, ICDs, neural network, and the like). Additionally or alternatively, the patients may be categorized as similar based on demographic data (e.g., age, gender, location, and the like) or any other suitable grouping or shared characteristic. The peer group for a physician may be recognized by the system 500 based on other users of the system 500. The comparison costs come from the most recent patient admissions seen by the peer group.
The actual and scheduled charges compared against physicians covering an entire region for the same diagnoses codes. The region for a physician may be recognized by the system 500 based on other users of the system 500. The comparison costs come from the most recent patient admissions seen by other users of the system 500.
The actual and scheduled charges compared against physicians of the same specialty treating for the same diagnoses codes. The same specialty group for a physician may be recognized by the system 500 based on other users of the system 500. The comparison costs come from the most recent patient admissions seen by the specialty group.
The actual and scheduled charges compared against a single physician's aggregated cost statistics for a group of patients over a period.

In some embodiments, the system 500 may provide feedback on orders that are placed for a patient. The feedback may relate to the practices of other physicians treating patients with the same or similar diagnosis, and be based on historical information. Such historical information may be gathered over time for a particular facility, a group of facilities, a group of physicians, or any other suitable group that shares at least one characteristic. For example, if a physician orders an x-ray for a patient, the system 500 may inform the physician how frequently that x-ray order is associated with treating that diagnosis. In some embodiments, for orders that are very common with the patient's diagnosis, the system 500 might not generate an alert, but for orders that are comparatively rare (e.g., other physicians order the x-ray less than 5% of the time, or less than 20% of the time, or any other suitable threshold), the system 500 generates an alert. The alert may be displayed at the HVA client application 508, and may be similar to the following: “For patients with this diagnosis, the x-ray order is only seen in 3% of the treatment plans.” Similarly, the system 500 may provide feedback on orders based on best practice treatment protocols for a diagnosis. Some hospitals, facilities, and provider groups have developed best practice treatment protocols for each diagnosis. In such cases, the system 500 may provide an alert if an order is outside the predetermined protocol.

In some embodiments, the system 500 may provide information about orders commonly associated with a particular diagnosis. Such information may relate to the practices of other physicians treating patients with the same or similar diagnosis, and be based on historical information. For example, if a patient is assigned a diagnosis of pneumonia, the system 500 can inform the physician what are the most common orders prescribed for patients with a diagnosis of pneumonia. In some embodiments, the orders may be ranked by how frequently the orders are associated with treating the diagnosis (i.e., frequency of use) or by category of care (e.g., labs, radiology, etc.). As a particular example, the orders may be presented as a list that is ordered by rank and is displayed at the HVA client application 508. As another example, the orders may be grouped by day or other period during a length of a visit or a length of care (e.g., most common orders for Day 1 of a hospital visit, most common orders for Day 2 of the hospital visit, etc.). In some embodiments, information about orders may be related to a total cost to treat. For example, the system 500 may inform the physician which orders have been historically associated with patients whose total cost to treat was less than an average cost to treat, as a way of indicating that such orders are associated with good outcomes. In some embodiments, the physician may select orders directly from the displayed list.

In some embodiments, when a patient is discharged, a communication may be sent to the HVA server 502 so that an end of a visit may be recorded for the patient. Once this event occurs, further communications from the EMR system 504 may not be needed for this patient. The system 500 may maintain a persistent HVA value analysis for a discharged patient (e.g., at a database in the HVA server 502).

The progress bar is displayed in the HVA client application 508 based on the expected reimbursement or average cost to the hospital or facility to treat the patient; this cost is based on the diagnosis for the patient. It is common for the DRG to change throughout the facility visit period. In such cases, the progress bar displayed in the HVA client application 508 may be updated to reflect the change whenever a new DRG code is received for a patient. Similarly, the average cost to treat may be modified at one or more points during a patient visit based on how the patient progresses, the outcome of one or more procedures, and the like.

In some cases, a working DRG code and illness severity may not be available right away when a patient is admitted to the hospital or facility. In fact, it may be many hours or even days later before even a working DRG code is known. In some embodiments, the HVA client application 508 may indicate that no DRG is currently available for this patient. In some embodiments, the system 500 may use a generic baseline DRG or a baseline diagnosis that is discerned from initial evaluation of patient symptoms.

Because some payment reform models are trending toward a single lump sum payment to a facility that includes health care provider fees, in some embodiments, the average cost to treat may include both facility costs and health care provider (e.g., physician) fees. Additionally, from that single payment, physicians and other health care workers may need to negotiate their fees with the facility. The system 500 may facilitate a “share in savings” model where the physician fees are based on the value (cost versus reimbursement) the physician provided to the patient.

Although FIG. 5A illustrates one example of a system 500 for determining and indicating value of health care, various changes may be made to FIG. 5A. For example, various components in FIG. 5A may be combined, further subdivided, rearranged, or omitted and additional components may be added according to particular needs.

FIG. 6 illustrates an example method 600 for determining and indicating value of health care according to this disclosure. For ease of explanation, the method 600 is described as being performed using the system 500 of FIGS. 5A-5D. However, the method 600 may be used with any suitable device or system.

At step 601, the system 500 determines an average cost to treat, an expected reimbursement, or both, for a DRG associated with a patient. This may include, for example, the HVA server 502 calculating the average cost to treat based on an average cost of treatment for all patients having the same diagnosis that are treated by a predetermined group of physicians (e.g., the physicians affiliated with the health care facility) over a predetermined historical period (e.g., the two previous years) or at a predetermined group of health care facilities over a predetermined historical time period. Additionally, or alternatively, this may include the HVA server 502 calculating the average cost to treat based on a designed plan of care for the DRG.

At step 603, the system 500 receives an indication of one or more health care services provided or scheduled for the patient. This may include, for example, a health care provider (e.g., a physician) entering one or more orders into the CPOE system and then the HVA server 502 receiving the order or an indication of the order from the EMR system 504.

At step 605, the system 500 determines a cost for each of the health care services. This may include, for example, the HVA server 502 obtaining the cost(s) from the facility charge master 506 or calculating the cost(s) based on information from the facility charge master 506.

At step 607, the system 500 then aggregates the costs for the health care services to determine a total aggregated cost. This may include, for example, the HVA server 502 adding each of the individual costs together.

At step 609, the system 500 configures an indicator to indicate the total aggregated cost relative to the average cost to treat or the expected reimbursement, and then displays the indicator to a user. This may include, for example, the HVA server 502 configuring a progress bar, such as the progress bar 304 or the progress bar 404. Once the progress bar is configured for display, a client application, such as the HVA client application 508 may display the progress bar.

Steps 603-609 may be repeated as the health care provider enters new orders or new costs are aggregated. All operations described in the method 600 may be performed in real-time in to provide a real-time display to a user as patient orders are entered and costs are aggregated.

Although FIG. 6 illustrates one example of a method 600 for determining and indicating value of health care, various changes may be made to FIG. 6. For example, while shown as a series of steps, various steps shown in FIG. 6 may overlap, occur in parallel, occur in a different order, or occur multiple times. Moreover, some steps may be combined or removed and additional steps may be added according to particular needs.

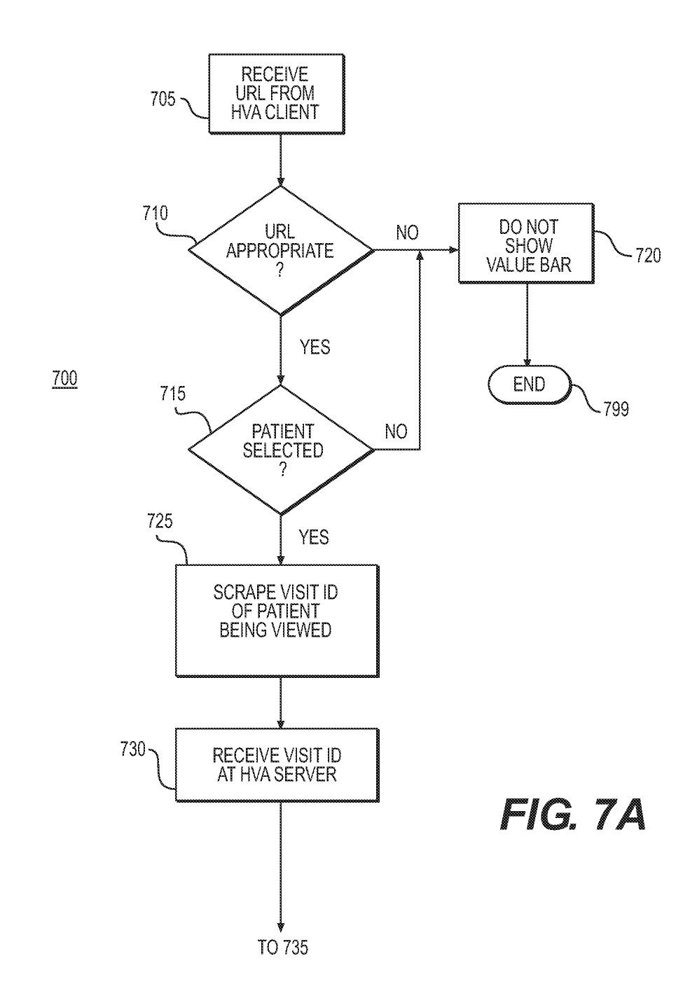

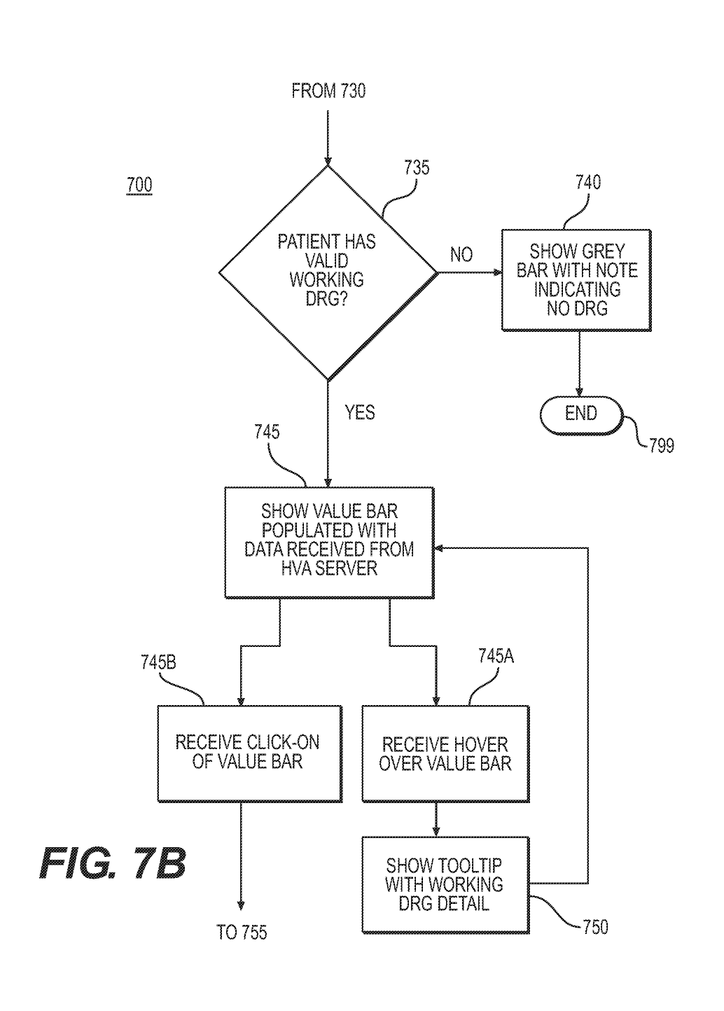

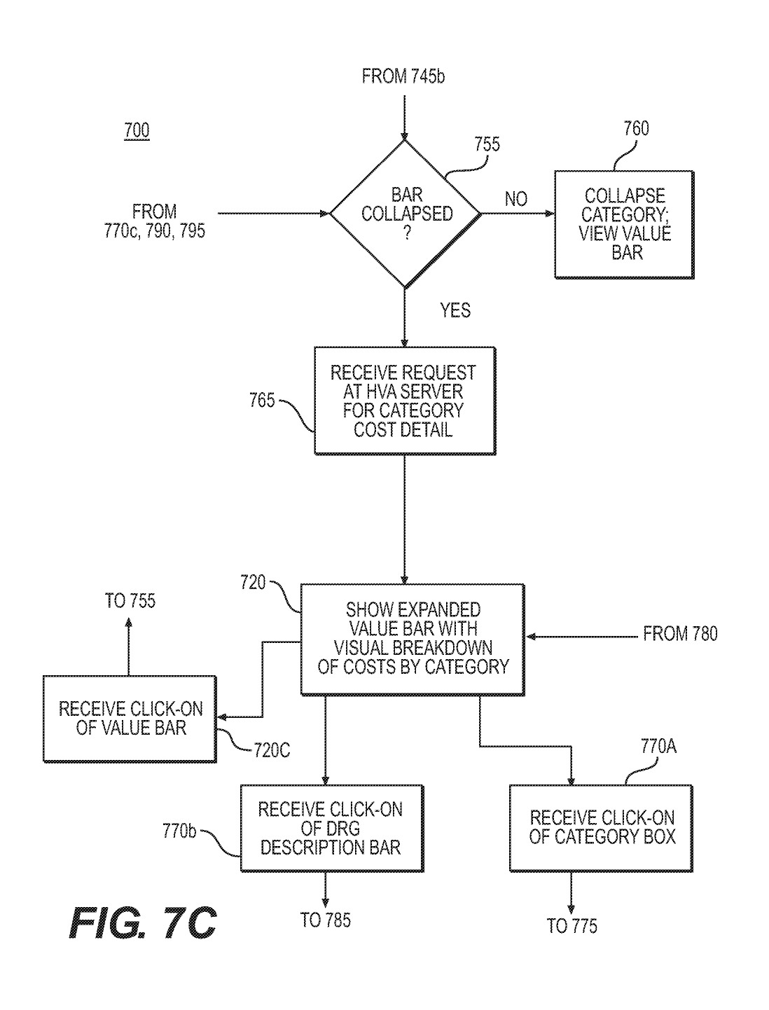

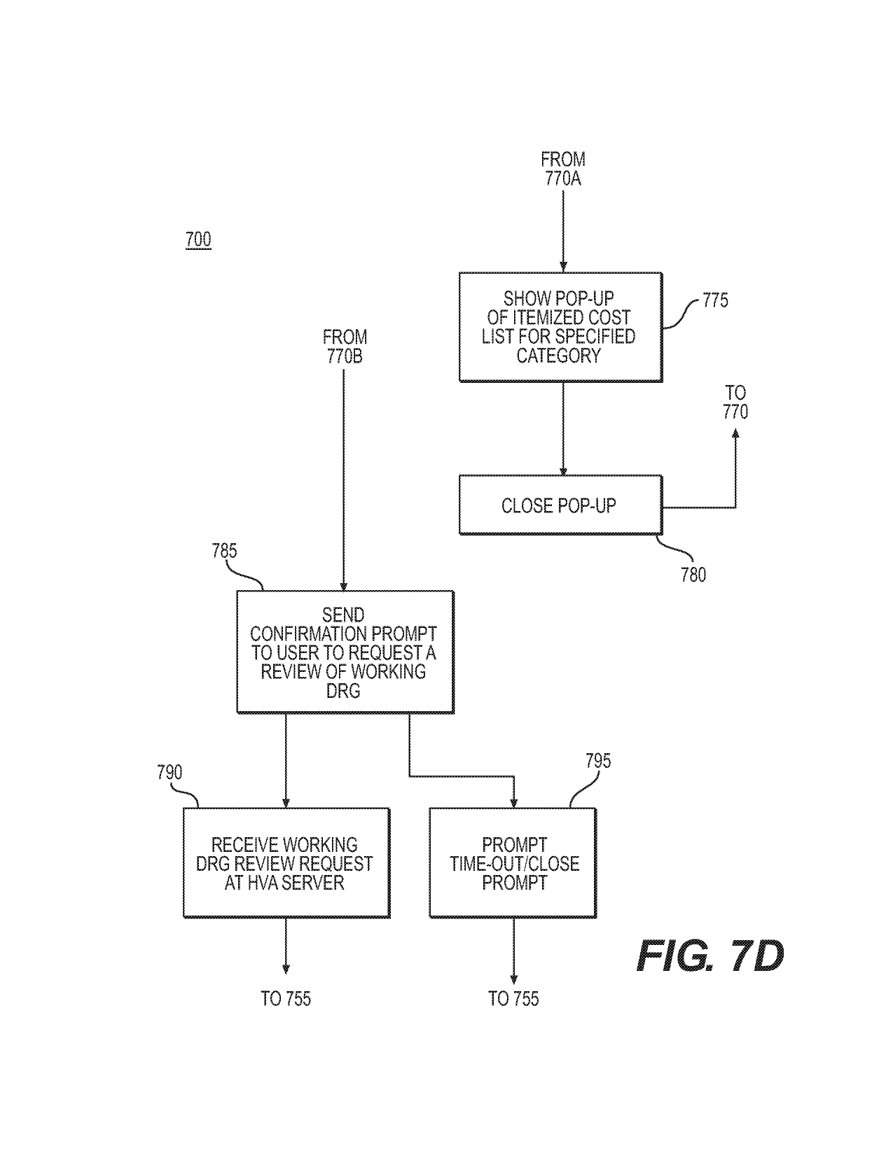

FIGS. 7A-7D illustrate still another example operation of components of the system 500 of FIGS. 5A-5D, most notably, interaction between the HVA client application 508 and the HVA server 502 to display the value continuum and corresponding progress bar. The illustrated operation is based on a scenario involving operation of the system 500 in which physician provider device 501A accesses EMR user interface client 503 (or another appropriate user device) to access electronic medical records for an existing patient, the records stored in the EMR system 504, as part of a hospital admission process. In FIG. 7A, operation 700 begins in block 705, when the HVA client application 508 (through, for example, the event listener 542) detects an event or activity that may warrant generation and display (or update and display) of a value continuum and corresponding progress bar; in this example, the activity is log on to the EMR system 504 by the physician provider 501A and the HVA client application 508 receives a URL associated with the log on. In block 710, the HVA client application 508 determines if the URL is appropriate; for example, the HVA client application 508 may determine if the URL is a “recognized” or “approved” URL—that is, a URL appropriate for the EMR system 504. In block 710, if the URL is “not appropriate,” the operation 700 moves to block 720 and the HVA client application 508 does not send a request 507 to the HVA server 502 does not present data necessary for the HVA client application 508 to display the value continuum and the corresponding progress bar. Following block 720, the operation 700 moves to block 799 and ends. In block 710, if the URL is appropriate, the operation 700 moves to block 715, and the HVA client application 508 determines if the physician provider activity (i.e., the example log in to the EMR system 504) identifies a patient in the EMR system 504 (note that a new, or first-time patient, may be entered into the EMR system 504 as a new patient as part of the log in that proceeds the operation 700 commences). If a patient is not selected from patients in the EMR system 504 (or a new patient identified), the operation 700 returns to block 720, and ultimately ends, block 799. If in block 715, a patient from the EMR system 504 is selected, the operation 700 moves to block 725. Note that, as disclosed above with respect to FIG. 5B, a request 507 may include state information in a part of the request 507 such that the communication of the request 507 to the HVA server 502 does not initiate a session in which the HVA server 502 must maintain state information.

In block 725, the HVA client application 508 scrapes a Visit ID (or, simply, a visit) of the selected patient, and in block 730 the HVA server 502 receives the Visit ID for use in further processes under operation 700. For example, in block 735, the HVA server 502 determines, based on the visit, if the selected patient has a valid working DRG. If the selected patient does not have a valid working DRG, the operation 700 moves to block 740 and the HVA server 502 responds to the request 507 to show at the HVA client application 508 display, a grey bar with a note that the selected patient does not have a working DRG (the working DRG may be created by execution of other operations such as the physician provider device 501A accessing the CPOR module 504A to enter orders and the CDI specialist device 501B entering appropriate medical codes. The operation 700 then moves to block 799 and ends. In block 735, if the selected patient does have a valid working DRG, the operation 700 moves to block 745, and the HVA server 502 provides information to the HVA client application 508 to cause display of a value continuum and a corresponding progress bar populated with data extracted by the HVA server 502 from the EMR system 504. Following block 745, the operation 700 then proceeds to block 745A or 745B, depending on a request (signal) from the HVA client application 508. In block 745A, the HVA client application 508 receives an activity signal generated by hovering of a cursor or other pointing device over the progress bar displayed through the HVA client application 508, and sends a minimal request 507 to the HVA server 502. In response, the HVA server 502 determines if information related to the patient and the patient's treatment plans is available and, if so, provides information and instructions (block 750) that causes the HVA client application 508 to display a tool tip (see FIG. 8B) with working DRG details, on the display of the HVA client application 508. The tool tip display of block 750 persists as long as the cursor hovers over the progress bar. Once the hovering ends, the operation 700 returns to block 745, and the HVA server 502 causes the tool tip display to end. If, following block 745, the HVA server 502 receives a request 507 based on detection by the HVA client application 508 of a click-on of the progress bar, the operation 700 moves to block 755, and the HVA server 502 receives request 507 from the HVA client application 508 indicating if the progress bar is, or is not, collapsed. If in block 755, the HVA server 502 receives a request 507 that the progress bar is not collapsed, the HVA server 502 provides information and instructions that cause the category to collapse and the progress bar to be displayed. If in block 755, the HVA server 502 receives a request that the progress bar is collapsed, the operation 700 moves to block 765, and the HVA server 502 receives a request 507 to display category cost detail (see, for example, the category cost dials of FIG. 8A). Note that in blocks 745-765, the HVA client application 508 may send one request 507 embodying all the data requests of the individual requests of blocks 745-765. In response to the request 507 received at block 765, the operation 700 moves to block 770, and the HVA server 502 provides information and instruction to display an expanded progress bar with a visual breakdown of costs by category (see the example display 800 of FIGS. 8A and 8B). The categories may include one or more of Radiology, Pharma, Hospital Room, Procedures, Therapy, lab, and Other, for example.

When the expanded progress bar (FIGS. 8A and 8B) is displayed through the HVA client application 508, the HVA server 502 may receive one of three requests. In block 770A, the HVA server 502 may receive a request based on detection of a click-on of a category box; in block 770B, a click-on of a DRG description bar; and in block 770C, a click-on of the progress bar. Following block 770C, the operation 700 returns to block 755. Following block 770A, the operation 700 moves to block 775, and the HVA server 502 provides information and instructions that cause the HVA client application 508 to display a pop-up of the itemized cost list for the specified category. Following display of the pop-up in block 775, the HVA server 502 may receive, block 780, a close pop-up request and may provide information and instructions to the HVA client application 508 to cause the pop-up to close. Alternately, a user may execute a close instruction that is part of the pop-up, and is represented, for example, by an “X” appearing on the pop-up. In either event, following closure of the pop-up, the operation 700 returns to block 770. Following block 770B, the operation 700 moves to block 785, and the HVA server 502 sends information and instructions to display at the HVA client application 508, a confirmation prompt to prompt a user of the HVA client application 508 to confirm a request for a review of the working DRG. In response to the prompt, the HVA server 502 may receive, block 790, a request 507 for a working DRG review. Otherwise, after a set time, the HVA server 502 causes the prompt to close, block 795. Following either block 790 or 795, the operation 700 returns to block 755.

The operation 700 of FIGS. 7A-7D may require a number of requests 507 and responses 509 between the HVA client application 508 and the HVA server 502. As noted above, the requests 507 and responses 509 may follow a stateless architecture 505 in which the request 507 provides the desired state and the response 509 repeats the state. Thus, the operation 700 executes without the need to establish a session at the HVA server 502, and each request-response pair is a self-contained procedure, thereby increasing the efficiency and accuracy of the operation 700 and its execution by the HVA server 502. Alternately, the system 500 may employ a stateful architecture.

FIGS. 8A-8C illustrate example displays for determining and indicating value of health care that may be generated by the system of FIGS. 5A-5D.

FIG. 8A illustrates HVA display 800, which is seen to include value continuum 801, which in turn includes progress bar 804. The value continuum 801 also includes a breakout of value continuum categories (for example, Pharma, with cost progress represented by dials). The dials 806 show the same regional green, yellow, and red scales as the progress bar 804 for each component of the patient's treatment plan (the designed plan of care). Note that the value continuum and progress bar are shown expanded—the individual categories (Radiology, Lab, Procedures, Therapy, Pharma, Room, Other) are broken out, as opposed to what would be shown in a collapsed progress bar format such as that of FIG. 4. The display also shows current length of stay 805 for the patient. Finally, assuming the display 800 is provided to a physician provider, the display 800 may include a list 810 all patients of the physician provider, and the physician provider may click on any of the patients to determine the cost to date for a visit of the patient. (Note that the event listener 542 may detect such a click-on as an activity that may trigger a need to recompute the patient's value continuum and that would trigger a request to stope display of the value continuum for the previously selected patient.).

FIG. 8B shows display 800 with a drill down to show a cost comparison and related data 820 for a prescription order placed by the physician provider for a currently selected patient. The cost comparison and related data 820 includes charge code, description, cost, and a comparison to the number (percentage) of visits with the same charge code.

FIG. 8C illustrates a value portal and alert system display 830. The display 830 may include, for each patient visit (referenced by Visit ID 833) DRG status 831, indicating if a working DRG exists and is tracking, as well as a DRG reference 832. The display 830 further includes a cost alert 834 showing cost progress to date as a percentage of expected cost to treat for the reference DRG. The display still further includes hospital room assignment data, procedure data and admission data 836. Finally, the display 830 includes physician DRG reviews ordered 838. Note that some of the data presented in the display 830 includes data useable by the HVA client application 508 during execution of operation 700 (FIGS. 7A-7D) to determine whether to send a request to the HVA server 502. For example, if a DRG does not exist for a specific Visit ID 833, the HVA client application 508 does not send a request to the HVA server 502.

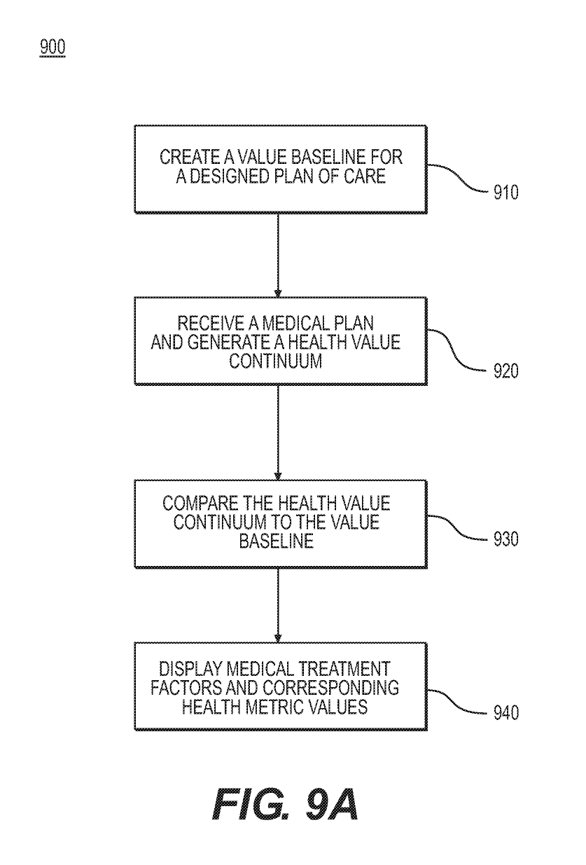

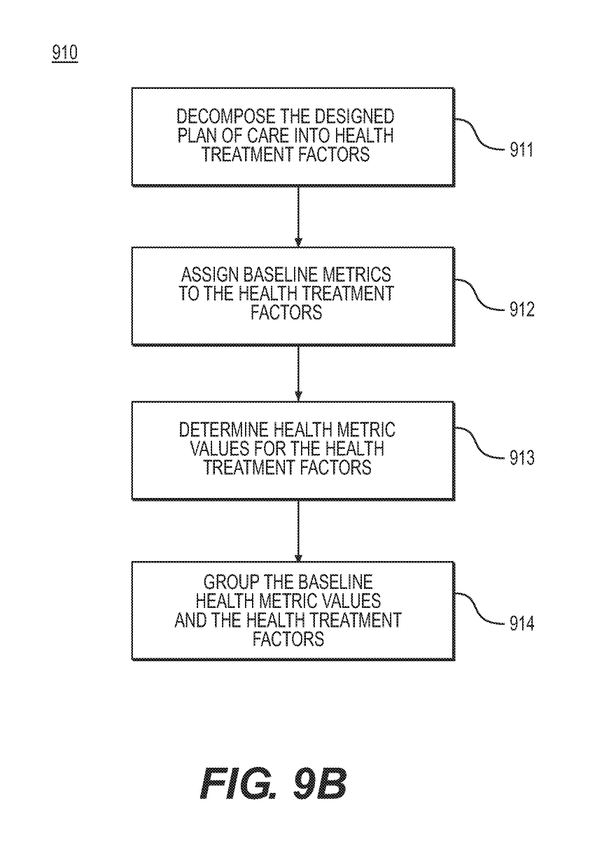

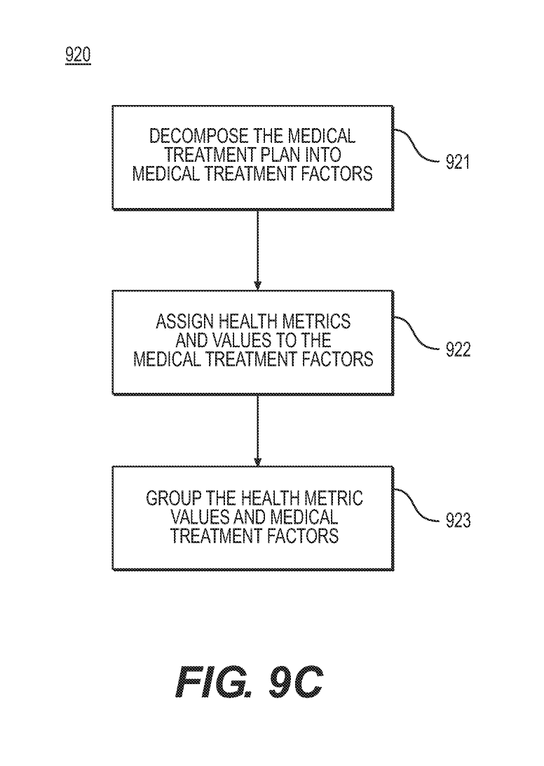

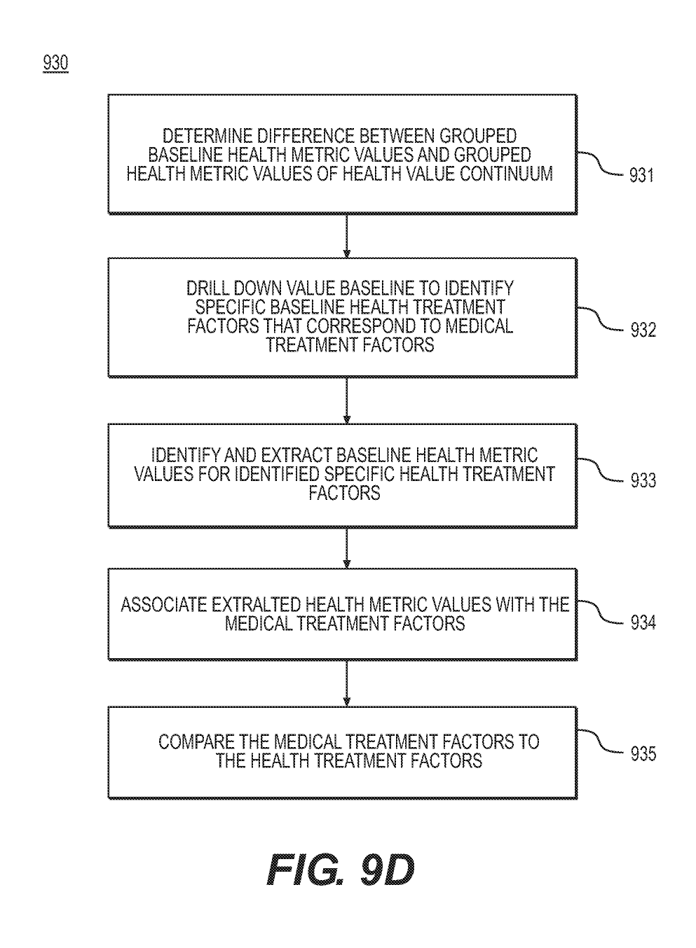

FIGS. 9A-9D illustrate yet another example operation of the system of FIGS. 5A-5D. In FIG. 9A, operation 900 begins in block 910 with the HVA server 502 creating a value baseline for a designated plan of care. In block 920, the HVA server 502 receives a medical plan and generates a health value continuum. In block 930, the HVA server 502 compares the health value continuum to the value baseline. Finally, in block 940, the HVA server 502 displays medical treatment factors and corresponding to the health value metrics.

FIG. 9B illustrates the operation 910 in detail. In block 911, the HVA server 502 operates to decompose the designed plan of care into individual health treatment factors. In block 912, the HVA server 502 operates to assign baseline metrics to the health treatment factors. In block 913, the HVA server 502 operates to determine health metric values for the health treatment factors. Finally, in block 914, the HVA server 502 operates to group the baseline health metric values and the health treatment factors to create the value baseline for the designated plan of care.

FIG. 9C illustrates operation 920 in detail. In block 921, the HVA server 502 operates to decompose the medical treatment plan into medical treatment factors. In block 922, the HVA server 502 operates to assign health metrics and corresponding values to the medical treatment factors. Finally, in block 923, the HVA server 502 operates to group the health metric values and medical treatment factors to generate the health value continuum.

FIG. 9D illustrates the operation 930 in more detail. In block 931, the HVA server 502 operates to determine a difference between the grouped baseline health metric values and the grouped health metric values of the health value continuum. In block 932, the HVA server 502 operates to drill down the value baseline to identify specific baseline health treatment factors that correspond to medical treatment factors. In block 933, the HVA server 502 operates to identify and extract baseline health metric values for the identified specific health treatment factors. In block 934, the HVA server 502 operates to associate the extracted health metric values with the medical treatment factors. Finally, in block 935, the HVA server 502 operates to compare the medical treatment factors to the health treatment factors.

FIGS. 10A-10C illustrate alternate embodiments of a system for determining and indicating value of health care. In FIG. 10A, system 1000 includes EMR system 1004, which is seen to include health valuation analytics (HVA) server 1002. The HVA server 1002 may be accessed by health valuation application client 1008. The EMR system 1004 may be accessed by EMR user interface client 1027. The valuation application client 1008 and EMR user interface client 1027 may be separate applications installed on and executed by physician provider device 1029. The EMR system 1004 may be accessed by CDI specialist device 1021 (for code entries, for example) and operating room scheduler 1023. The EMR system 1004 may access an external CPOE client 1023. Finally, the EMR system 1004 may access various data stores including facility charge master 1011, historical visit by average DRG cost 1013, average cost to treat DRG 1015, and expected patient cost 1017. However, the data stores 1013, 1015, and 1017 may be combined, and are part of the EMR system 1004.

Aspects of operation of the system 1000 differ from those of the system 500 of FIGS. 5A-5D because of incorporation of the HVA server 1002 into the EMR system 1004. In particular, communications between a separate HVA server and the EMR system 1004 no longer exist since the HVA server 1002 is integrated into the EMR system 1002. With this integrated architecture, the various cost analytics and value continuum analytics are executed, however, using a minimal request and event or activity listening protocol that is similar to that employed in the system 500 of FIGS. 5A-5D. For example, a physician provider, operating the device 1029, may add an order to a patient's treatment plan using the EMR user interface client 1027 (and the CPOE 1023), and the HVA client application 1008 will determine that such activity warrants possible recomputation of the value continuum and progress bar, and send a minimal request to the HVA server 1002. Thus, similar events occurring in the system 500 and in the system 1000 may be handled similarly.

FIG. 10B illustrates system 1100 for determining and indicating value of health care, in which EMR system 1110 is seen to include EMR server 1120 and EMR and HVA interface client 1130. EMR system 1110 is coupled to HVA server 1140 and user device 1140. The HVA server 1140 connects to HVA data store 1141. The EMR server 1120 includes processor 1122 and records store 1124, which houses the patient electronic medical records. Note that in FIG. 10B, the EMR system 1110 may be within a firewall and the other illustrated components may be outside a firewall; alternately, all components of the system 1100 may be inside a firewall or other combinations of components may be inside or outside the firewall.

Aspects of operation of the system 1100 may differ from operation of the system 500 of FIGS. 5A-5D in some respects. For example, when a physician provider operates user device 1150 to enter an order, the integrated client application 1130 determines if the order corresponds to an event or activity that warrant possible recomputation of the value continuum and progress bar established for a current visit of the patient receiving the order. If the recomputation may be necessary, the EMR system 1110 sends a minimal request to the HVA server 1140, The HVA server 1140 may access data from the EMR server 1120 and executes instructions to recompute the value continuum and progress bar data. The HVA server 1140 then sends a response to the HVA system 1110, and the EMR/HVA client application 1130 provides the updated value continuum and progress bar for viewing by the physician provider operating he user device 1150.

FIG. 10C illustrates system 1200 for determining and indicating value of health care, in which EMR system 1210 is seen to include integrated EMR/HVA server 1120, which accesses records store 1230. Records store 1230 includes patient electronic medical records and HVA data. The EMR system may be behind a firewall. Alternately, all components of the illustrated system 1200 may be inside a firewall. A CDI specialist may operate device 1260 to access the EMR system 1210. A physician provider may operate device 1250 to access the EMR system 1210. The device 1250 may have installed separate or integrated EMR/HVA client applications—in FIG. 10C the applications are integrated as client application 1240. The integrated client application 1240 executes to perform operations similar to those of the client applications of FIGS. 5A-5D, 10A and 10B.

Any of the systems of FIGS. 5A-5D and 10A-10C may, in addition to the above-disclosed features, invoke additional features to further improve bandwidth utilization and reduce network load, particularly during peak periods of operation. For example, the HVA client application 508 and HVA server 503 (and the EMR system 504) of FIG. 5A may invoke quality of service protocols that prioritize request and response movement in the system 500. As an example, the first activity the event listener 542 may detect may be an initial log in by a physician provider to admit a patient to the hospital (presumably, the Physician provider has established a Visit ID and provided a diagnosis and one or more orders (a medical treatment plan) for the patient. As noted above, such activity may cause the HVA client application 508 to request the HVA server 502 generate a value continuum for the patient/Visit ID. Such a request may, in the system 500, be accorded a higher priority than other requests from the same or other HVA client applications, and the request, therefore, is moved ahead in a queue above pending update requests. In another example, the HVA client application 508 may determine that a new order, or a navigation event, is a minor event, and may delay submission of the corresponding request based on monitored bandwidth use. In either situation, however, request handling and response occur quickly, and, as perceived by the providing physician, occur in “real time.”

The disclosed embodiments are also particularly useful for prepaid or bundled medical services, including, but not limited to, health maintenance organizations (HMOs) and clinically integrated networks (CINs). In these environments, the disclosed progress bar may track costs for a defined period against a contracted prepaid or bundled amount. As services are deployed and resources are consumed, a health care provider may quickly see exactly how the provider is performing in the value of care continuum for each patient with prepaid or bundled medical services.

As described above, embodiments of this disclosure provide the ability to link the cost side of patient care at the point of the provider with the reimbursement side of the patient care from the third party payer. Once the expected reimbursement is determined, that information will be entered into the system. The disclosed embodiments also provide the ability to link actual costs with estimated average costs to treat. As the primary driver of cost, the physician or other health care provider is able to monitor in relative terms or in precise terms the cost of his care during each phase of the care continuum. By linking the physician with these financial components, improved awareness and greater value for care provided will result in finally bending the cost of the health care curve downward.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. A processor-implemented method for determining and indicating values of medical treatment plans, comprising a processor:
creating value baselines comprising health metric values for approved plans of care;
receiving a request from a client device based on the client device detecting an activity indicating a patient-related event, the request identifying a visit associated with a patient;
generating a health value continuum based on the visit;
generating a comparison of the health value continuum to a value baseline; and
providing data and instructions to display on a display page, a representation of the health value continuum to value baseline comparison.

2. The method of claim 2, wherein the patient-related event comprises a patient visit that has an associated diagnosis.

3. The method of claim 1, comprising receiving a second request from the client device based on the client device detecting a second activity indicating a second patient-related event; and
returning updated data and instructions to provide an updated display of the representation of the health value continuum to value baseline comparison.

4. The method of claim 3, wherein the second request further is based on the client device determining that the detected second activity comprises a change to a cost basis of the health value continuum.

5. The method of claim 3, wherein the second request further is based on the client device determining the detected second activity comprises navigation away from the display page, and wherein the display update comprises termination of the representation of the health value continuum to value baseline comparison.

6. The method of claim 3, wherein the client device and the processor are connected through a browser-based system, and wherein:
the requests the client device provides are minimal requests comprising requests only for data and instructions to invoke updates to the representation of the health value continuum to value baseline comparison; and
the requests are sent to a URL associated with the processor.

7. A method for determining and indicating values of medical treatment plans, the method executed over a client-server architecture, comprising:
a server creating value baselines comprising health metric values for approved plans of care;
a client detecting activity related to medical care for a patient;
the client sending and the server receiving a request from the client device identifying a patient visit that has an associated diagnosis; and
the server:
determining the activity warrants generating a health value continuum,
generating a health value continuum corresponding to the diagnosis,
generating a comparison of the health value continuum to the value baseline, and
providing data and instructions to the client to display a representation of the health value continuum to value baseline comparison.

8. The method of claim 7, wherein the client detecting activity related to medical care for a patient comprises the client monitoring actions at a medical provider device, separate from the client and separate from the server, indicating an admission of the patient to a hospital.

9. The method of claim 8, wherein the client detecting activity related to medical care for the patient comprises the client monitoring actions at the medical provider device indicating updates to the medical treatment plan, wherein
the client requests an update to the health value continuum;
the server receives the request, generates updates to the health value continuum, and provides the update and update instructions to the client; and
the client executes the update instructions and displays an updated representation of the health value continuum to value baseline.

10. The method of claim 9, wherein the client and server are invoked on a single hardware platform, and wherein the requests and responses comprise minimal data requests.

11. The method of claim 9, wherein the client and server are invoked on separate hardware platforms coupled through a browser-based network architecture, and wherein:
the requests the client provides are minimal requests comprising requests only for data and instructions to invoke updates to the representation of the health value continuum to value baseline comparison; and
the requests are sent to a URL associated with the server.

12. The method of claim 7, wherein the client and server execute a quality of service protocol in which requests are placed in queue first in order of priority and second in order of receipt.

13. A method executed by a processor of a health value analytics system in communication with a device external to the health value analytics system, comprising the processor:
receiving an indication of a patient-related event from the external device, the patient-related event referencing a visit of a patient; and
based on the visit reference, the processor:
determining a need to generate a health value continuum:
directing generation of the health value continuum,
directing generation of a comparison of the health value continuum to a value baseline for an approved plan of care, and
directing the provision of data and instructions to display on a display page, a representation of the health value continuum to value baseline comparison.

14. The method of claim 13, comprising:
receiving from the external device, a second indication of a second patient-related event;
determining a need to provide a value continuum update based on the second patient-related event;
generating an update to the health value continuum and the comparison; and
providing data and instructions to the external device to display on the display page, a representation of the update to the comparison.

15. The method of claim 13, the comparison comprising a progress bar showing a current relation between the value baseline and the value continuum, the progress bar indicating a cost to date to treat the patient.

16. The method of claim 15, the monitoring, comprising the client:
listening to communications between the external device and the processor;
evaluating the communications to identify communications from the external device to the processor comprising patient-related events;
generating the indication of the patient-related event; and
sending the indication of the patient-related event to the processor.

17. A method for determining and indicating values of medical treatment plans, comprising a server, in communication with a client:
receiving from the client a communication defining a patient-related event;
the server, in response to the communication:
determining a need to generate a value continuum,
generating the value continuum,
generating a comparison of the value continuum to a value baselines comprising health metric values of a designed plan of care, and
providing a representation of the comparison, and instructions, to the client to display the representation of the comparison.

18. The method of claim 17, comprising the server generating the value baseline, wherein the patient-related event comprises one or more of:
admission of a patient to a hospital;
a diagnosis of a medical condition of the patient; and
one or more orders to treat the medical condition, the one or more orders comprising a medical treatment plan for the patient, and wherein the value continuum comprises a cost for each of the one or more orders.

19. The method of claim 18, wherein the designed plan of care is based on an event corresponding to the patient-related event.

20. The method of claim 19, wherein the server determining a need to generate a value continuum comprises the server;
determining the patient-related event comprises an action that:
creates a cost to treat the patient, and
changes a cost to treat the patient.
